(19) United States
(12) Patent Application Publication
(10) Pub. No.: US 2022/0083902 A1
(43) Pub. Date: Mar. 17, 2022

(54) Discrete Learning Engine Device

(71) Applicant: Uzochukwu Okolo, San Diego, CA (US)

(72) Inventor: Uzochukwu Okolo, San Diego, CA (US)

(21) Appl. No.: 17/019,287

(22) Filed: Sep. 13, 2020

(51) Int. Cl. G06N 20/00; G09B 5/00; G06N 5/00

(52) U.S. Cl. CPC G06N 20/00; G06N 5/003; G09B 5/00

(57) ABSTRACT

A Discrete Learning Engine Device is connectable to a specially-programmed artificial intelligence computer. Once activated, the Device engages a Dynamic Response Optimization Module, a Derivative Network Controller, an Activity Risk Monitor, and an Integrated Publication Manager, all residing on the specially-programmed artificial intelligence computer. The Dynamic Response Optimization Module automates responses to the user. The Derivative Network Controller create a link to one or more other computers having a similar Device. The Activity Risk Monitor identifies patterns found in use of the learning resources embedded in the Device. The Integrated Publication Manager derives conclusions from work by the user and enables any of the one or more other computers linked by the Derivative Network Controller to print the conclusions.

### TECHNICAL FIELD

In the field of education, an apparatus and processes providing instruction about a subject or means; testing or grading a person's knowledge, skill, discipline, or mental or physical ability using integrated multi-layered engagement networks and artificial intelligence.

### BACKGROUND ART

Digital learning has gained momentum since the early 2000's following the growth in internet usage and the wide use of computers to create and deliver content. Educational institutions and corporations have relied on learning management systems to create and distribute content to their students and employees. In the case of school systems, learning management systems have been used to conveniently deliver content to students, generate class assignments and grade student performance.

Corporations use learning management systems to train their employees. Other digital learning systems exist to enable students to engage with tutors digitally or to post questions to peers in a forum. These systems are mostly created with a set of defined parameters that do not account for variation in student learning styles and they also lack sufficient permission to drive multi-layered engagement process among learners with similar interests. They are also not stand-alone devices that enhance personalized learning at the individual level as well as managing the exchange of academic ideas among network participants through connection to a computer.

### SUMMARY OF INVENTION

A Discrete Learning Engine Device to facilitate remote learning is a unit connectable to a specially-programmed artificial intelligence computer and is configured to be activated by a user once it is connected to the specially-programmed artificial intelligence computer. Once activated, the Discrete Learning Engine Device engages a Dynamic Response Optimization Module, a Derivative Network Controller, an Activity Risk Monitor, and an Integrated Publication Manager, all residing on the specially-programmed artificial intelligence computer.

The Dynamic Response Optimization Module is configured to automate a response to the user when the user sends a question on learning resources embedded in the Discrete Learning Engine Device. The Dynamic Response Optimization Module may be further configured to collect enrollment information from the user, the enrollment information comprising prior history learning performance statistics, and further configured to use the enrollment information to create a recommendation to the user to address any identified learning gap or academic failure risk.

The Derivative Network Controller is configured to create a link to one or more other computers having a similar Discrete Learning Engine Device. The Derivative Network Controller may be further configured to enable one-on-one communication between the user and any of the one or more other computers to which the link was created. Additionally, the Derivative Network Controller connects users with shared academic interests and circumstances across multiple engagement networks.

The Activity Risk Monitor is configured to identify patterns found in use of the learning resources embedded in the Discrete Learning Engine Device. And, The Integrated Publication Manager is configured to derive a conclusion from work by the user with the learning resources embedded in the Discrete Learning Engine Device and to enable any of the one or more other computers linked by the Derivative Network Controller to print this conclusion.

The Discrete Learning Engine Device may be a separate, stand-alone unit, or may be a unit that is installed within the specially-programmed artificial intelligence computer, or may be a unit that is installed within a personal computer of the user.

The Discrete Learning Engine Device may include a component configured to connect wirelessly to the specially-programmed artificial intelligence computer, or to the personal computer of the user.

The Discrete Learning Engine Device may include a network connection that enables the unit to be connectable to the specially-programmed artificial intelligence computer through said network connection.

The Dynamic Response Optimization Module may further include a Learning Path Generator configured to implement diagnostic testing of the user and thereafter further configured to use results of the diagnostic testing to create a recommendation on goals for learning achievement.

The Dynamic Response Optimization Module may further include an answer validation key configured to provide step-by-step predictive guided feedback to a diagnostic or practice test session taken by the user as the user solves every step required by the diagnostic or practice test.

### Technical Problem

Existing learning management systems or student discussion boards do not have multiple engagement connecting points that allow students to seek and obtain very quick support from their peers or experts who are most familiar with their curriculum and who belong to individual networks connected across diverse demographic and geographic boundaries.

Additionally, existing learning management systems or student discussion board systems are not equipped with a Discrete Learning Engine Device which supports real time step by step feedback to students as they input responses into the system using an answer validation key.

The absence of the Discrete Learning Engine Device from existing systems means that individual students studying alone or as network participants cannot take advantage of a tool that operates in conjunction with a specially programmed computer with artificial intelligence; which also possesses an Activity Risk Monitor, and whose functions are further enabled by the Dynamic Response Optimization Module as well as the Learning Path Generator which guides participants in reaching their academic goals.

These existing systems also lack a Derivative Network Controller, which is the glue that connects all the networks as a unified entity through enhanced common master data attribute flag, as well as common Discrete Learning Engine Device user deployment. To successfully connect the networks, each individual with the Discrete Learning Engine Device must connect to their individual specially programmed computer and then the Derivative Network Controller uses the common master data attribute, which may consist of the specific academic material recommended at one school and adopted broadly to connect network participants. All inquiries sent to the network are screened by the Derivative Network Controller for compliance with the common master data and Discrete Learning Engine Device attribute flag standards before execution may occur.

For example, a high school student in Chicago, Ill. may be struggling with a problem in Advanced Placement (AP) calculus after attending a class session at their school. The student may access the learning management system or student discussion board for information on how to solve the problem. In this scenario, existing systems do not allow the student to rely on a device such as the Discrete Learning Engine Device to help them target the inquiry to the accurate audience of students under the same circumstance as the aforementioned inquiring student across multiple layers of peer level student participants. These peers may range from fellow students at their immediate school (e.g. XYZ High School, Chicago), to a similarly situated student in a different state or a different country.

### Solution to Problem

A Discrete Learning Engine Device that creates an integrated system to achieve personalized learning and also engage participants in multiple engagement networks. Each engagement network is connected by a Derivative Network Controller which recognizes what each network participant has in common with others across individual schools, school districts, states, country and the world. The engagement networks are supported by the Discrete Learning Engine Device that is configured to advance the academic goals of individual students as well as those of engagement network participants.

### Advantageous Effects of Invention

The Discrete Learning Engine Device enables user actions that promote learning and sharing academic concepts, ideas and ultimately physical text books and other relevant academic materials. The Discrete Learning Engine Device uses a connection to a computer embedded with artificial intelligence capabilities. This connection augments personalized learning and enables diverse collaboration activity across integrated multi-layered networks of participants with shared learning interests.

A final product in using the Discrete Learning Engine Device for users through a plurality of user network levels, is the production of relevant physical text books/academic materials, evidencing the learnings from the actions of users. Additionally, an individual user is able to interact via the specially-programmed artificial intelligence computer with other users having shared educational interests.

### BRIEF DESCRIPTION OF DRAWINGS

The drawings illustrate preferred embodiments of the Discrete Learning Engine Device according to the disclosure. The reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a diagram of the components in the Discrete Learning Engine Device in the context of user computers.

FIG. 2 is a diagram listing the required components and limitations of the Discrete Learning Engine Device.

FIG. 3 is a diagram listing of optional components and limitations of the Discrete Learning Engine Device.

FIG. 4 is a diagram listing additional optional components and limitations of the Discrete Learning Engine Device.

FIG. 5 is a diagram of steps performed in utilizing the Discrete Learning Engine Device.

FIG. 6 is a diagram of additional steps performed in utilizing the Discrete Learning Engine Device.

FIG. 7 is a diagram of additional steps performed in utilizing the Discrete Learning Engine Device.

FIG. 8 is a diagram of additional steps performed in utilizing the Discrete Learning Engine Device.

FIG. 9 is a diagram of additional steps performed in utilizing the Discrete Learning Engine Device.

FIG. 10 is a diagram of additional steps performed in utilizing the Discrete Learning Engine Device.

FIG. 11 is a diagram of additional steps performed in utilizing the Discrete Learning Engine Device.

FIG. 12 is a diagram of additional steps performed in utilizing the Discrete Learning Engine Device.

FIG. 13 is a diagram of additional steps performed in utilizing the Discrete Learning Engine Device.

FIG. 14 is a diagram of additional steps performed in utilizing the Discrete Learning Engine Device.

FIG. 15 is a diagram of additional steps performed in utilizing the Discrete Learning Engine Device.

FIG. 16 is a diagram of additional steps performed in utilizing the Discrete Learning Engine Device.

FIG. 17 is an illustration of the potential users of the Discrete Learning Engine Device in the context of networks connecting those users.

FIG. 18 is an illustration of the interaction of components of the Discrete Learning Engine Device.

FIG. 19 is an illustration of the interaction of components of the Discrete Learning Engine Device.

FIG. 20 is an illustration of the interaction of components of the Discrete Learning Engine Device.

FIG. 21 is a flow diagram of utilization actions of the Activity Risk Monitor.

FIG. 22 is a flow diagram of additional utilization actions of the Activity Risk Monitor.

FIG. 23 is a flow diagram of additional utilization actions of the Activity Risk Monitor.

FIG. 24 is an illustration of a report generated in utilizing the Activity Risk Monitor.

FIG. 25 is an illustration of steps involved in student testing and the responses of the Discrete Learning Engine Device.

FIG. 26 is an illustration of additional steps involved in student testing and the responses of the Discrete Learning Engine Device.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention.

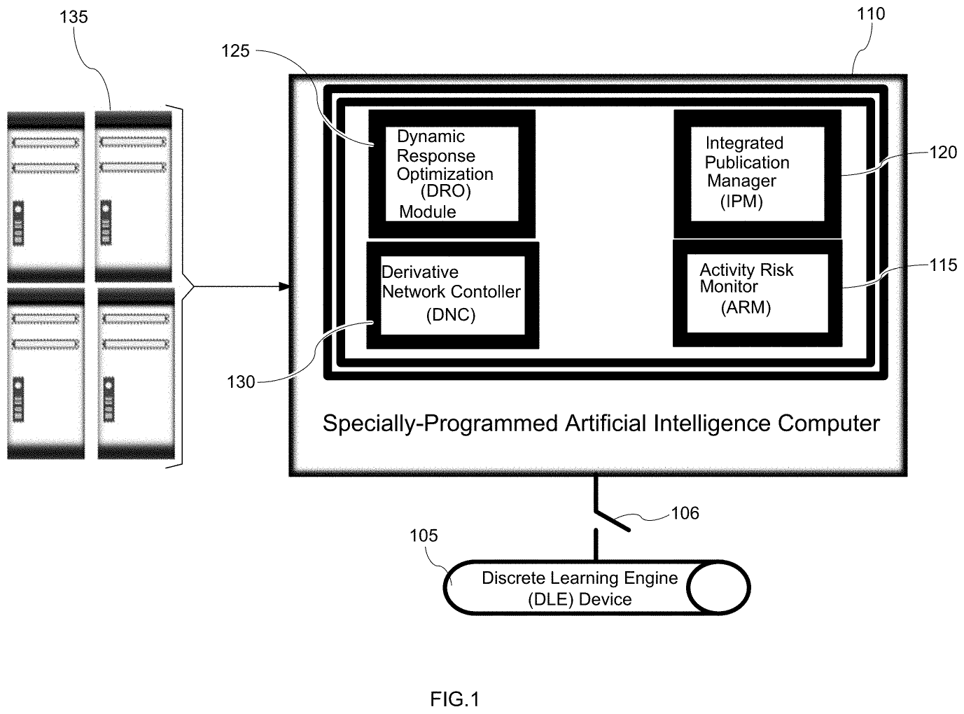

FIG. 1 is a diagram of the components in the Discrete Learning Engine Device (105) in the context of one or more user computers (135). The Discrete Learning Engine Device (105) is a unit that is connectable to a Specially-Programmed Artificial Intelligence Computer (110). A representation of a switch (106) represents the connection means, such as a standard cable connection interface or wired USB connection. The Specially-Programmed Artificial Intelligence Computer (110) includes a Dynamic Response Optimization Module (125); a Discrete Learning Engine Device (105); a Derivative Network Controller (130); an Activity Risk Monitor (115) and an Integrated Publication Manager (120).

Upon connecting the Discrete Learning Engine Device (105) with the Specially-Programmed Artificial Intelligence Computer (110), the Dynamic Response Optimization Module (125) allows the user to gain access to a wide range of learning resources embedded in the Discrete Learning Engine Device (105). For example, the student may take an academic diagnostic test, conduct interactive practice sessions or connect with peers with similar academic interests and circumstances to seek guidance.

The Discrete Learning Engine Device (105) and the Specially-Programmed Artificial Intelligence Computer (110) shown in FIG. 1 may be used to support individual learning activity as well as to augment user activity in multi-layered engagement networks. User actions conducted on the Specially-Programmed Artificial Intelligence Computer (110) with the support of the Discrete Learning Engine Device (105) are actions initiated by humans. The actions are preferably orchestrated by a diverse set of potential users. For example, students, teachers, parents, school administrators, employees, etc. These actions are initiated from mobile devices as well as other computer systems such as desktop and laptop computers. Interactions advanced by the Discrete Learning Engine Device (105) of each user are facilitated by connections through, for example, the internet and the resulting transactions may be stored in the cloud. Additionally, the artificial intelligence capabilities of the Specially-Programmed Artificial Intelligence Computer (110) may be supplied by an artificial intelligence system provider; with additional capability to support user engagement in multi-channel collaboration networks. The Specially-Programmed Artificial Intelligence Computer (110) is a specially programmed computer with non-transitory computer readable memory, such as RAM, ROM, DVD, CD or a hard drive.

The Discrete Learning Engine Device (105) is programmable and automatically implements steps upon activation, such as by any participating user operating the user's cellphone, personal computer or by an event responder such as to alert users to take action on a practice session, diagnostic test or class assignment.

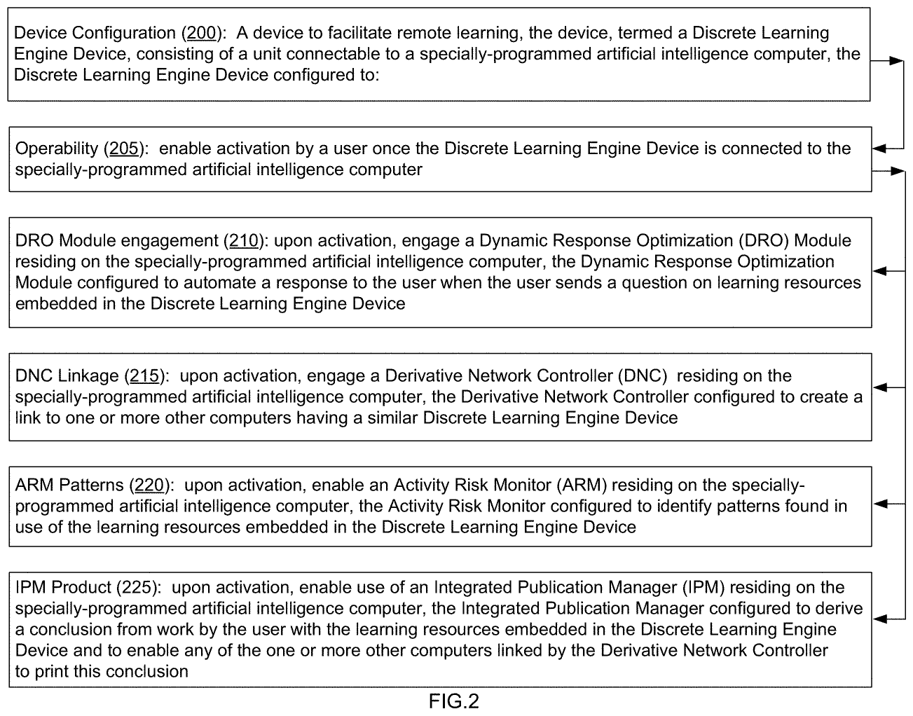

FIG. 2 further illustrates the components and limitations of the Discrete Learning Engine Device (105) and its interoperability with the Specially-Programmed Artificial Intelligence Computer (110).

A Device Configuration (200) for the Discrete Learning Engine Device (105) teaches that the Discrete Learning Engine Device (105) is a device to facilitate remote learning. This device is what is termed the Discrete Learning Engine Device (105).

The Discrete Learning Engine Device (105) consists of a unit connectable to a Specially-Programmed Artificial Intelligence Computer (110). The unit is a component that can stand alone for connection to the one or more user computers (135), such as for example, to a user's personal computer or for connection to the Specially-Programmed Artificial Intelligence Computer (110). The unit may also be a component that is integrated into one or more user computers (135) or into the Specially-Programmed Artificial Intelligence Computer (110).

An Operability (205) limitation requires that the Discrete Learning Engine Device (105) is configured to enable its activation by a user once the Discrete Learning Engine Device (105) is connected to the Specially-Programmed Artificial Intelligence Computer (110). This may be a wired or wireless connection, either directly or through another computer's network connection.

The Discrete Learning Engine Device processes each step of the learning process of individual users when operating alone, as well as of collective network participants when operating in collaboration networks. It depends on connection to the artificial intelligence driven machine to properly function. It aggregates both the individual users and subject matter expert inputs into its memory, advances the inputs to improve the engine and enhances the utility of the specially programmed artificial intelligence computer into its process.

When used by a plurality of users, network participants' interactions within the Discrete Learning Engine Device (105) occur through direct human interaction in either synchronous or asynchronous formats via an internet connection. The Discrete Learning Engine Device (105) captures the human to human interactions with a view to understanding patterns.

Alternatively, human network participants may directly interact with the Discrete Learning Engine Device (105) through an interface enabled by the Specially-Programmed Artificial Intelligence Computer (110).

Example of Interaction

An Example of human to Discrete Learning Engine Device (105) interaction is one that involves a student solving a math problem using a touchscreen device embedded with artificial intelligence. In this example, the Discrete Learning Engine Device (105) sends feedback to the student with each step of the problem being solved. When interaction occurs between network participants and the Discrete Learning Engine Device (105) through the said interface, they are also captured with a view to understanding patterns. The pattern recognition process improves the intelligence of the Discrete Learning Engine Device (105) to the extent that it is trained to improve its performance over time as more human to human as well as human to system interactions occur on discrete topics/subjects.

The improved intelligence of the Discrete Learning Engine Device (105) supports a series of decision points orchestrated without human intervention, thereby enabling artificial intelligence to sustain the decision point.

Example of AI Assistance

If a student gets stuck on a math problem, the Discrete Learning Engine Device (105) is trained to understand the peculiar nature of the problem faced by the student and systematically support solutioning without any human input, since it would have been trained to resolve different problems of wide-ranging levels of difficulty.

The Discrete Learning Engine Device (105) supports additional learning scenarios. For example, if a student takes a diagnostic test to measure the student's competency and readiness in a subject or topic, the Discrete Learning Engine Device (105) is responsible for supporting the teacher and or student in rectifying gaps identified. The remediation process may include deployment of Learning Path Generator (1905) driven by artificial intelligence and embedded in the Discrete Learning Engine Device (105). The Learning Path Generator (1905) contains decision steps required to guide the teacher in executing a learning plan in order to help the student in personalizing the learning process.

In another example, the Discrete Learning Engine Device (105) may deploy the Learning Path Generator (1905) to recommend steps a student may take to improve their grades after a test or exam has been aligned to both their engagement activity captured in the Discrete Learning Engine Device (105) as well as the expectation of student performance in the subject. The Learning Path Generator (1905) is a major component of the Discrete Learning Engine Device (105), because it supports the execution of the decision process involved in the engagement activities occurring within the Discrete Learning Engine Device (105).

A DRO Module engagement (210) limitation requires that the Discrete Learning Engine Device (105) is further configured to engage the Dynamic Response Optimization Module (125) residing on the Specially-Programmed Artificial Intelligence Computer (110) after the Discrete Learning Engine Device (105) has been activated. The Dynamic Response Optimization Module (125) is configured to automate a response to the user when the user sends a question on learning resources embedded in the Discrete Learning Engine Device (105). Thus, the Dynamic Response Optimization Module (125) has the capability to teach the user about resources residing on the Discrete Learning Engine Device (105).

The Dynamic Response Optimization Module (125) manages, organizes and automates responses to events. The events may include human to human or human to system interaction within the Discrete Learning Engine Device (105). The events may also be system to system interaction. For example, the process of connecting the Specially-Programmed Artificial Intelligence Computer (110) to the Discrete Learning Engine Device (105) for each individual user's learning needs or for a network engagement augmentation activity is supported by the Dynamic Response Optimization Module (125), as each activity represents an event to be managed between the entities involved.

The Dynamic Response Optimization Module (125) ensures that each event is properly and accurately initiated, processed and executed by the individual user or network participant. For example, if a network participant intends to make an inquiry in a discrete network tied to the Discrete Learning Engine Device (105), the Dynamic Response Optimization Module (125) may provide alternative methods of receiving responses to the inquiry namely: automated response orchestrated through the intelligent agents in the Discrete Learning Engine Device (105), or a highly rated response from a subject matter expert in a synchronous format, or a routing of the user inquiry to network participants and subject matter experts for their inputs to add to the body of knowledge on the topic. The input may be scheduled to be provided synchronously or asynchronously. The Dynamic Response Optimization Module (125) is an integral component of the Specially-Programmed Artificial Intelligence Computer (110), which each individual user has to access in using the Discrete Learning Engine Device (105).

A DNC Linkage (215) limitation requires that the Discrete Learning Engine Device (105) is further configured to engage the Derivative Network Controller (130) after the Discrete Learning Engine Device (105) has been activated. The Derivative Network Controller (130) resides on the Specially-Programmed Artificial Intelligence Computer (110). The Derivative Network Controller (130) is further configured to create a link to others of the one or more user computers (135) having a Discrete Learning Engine Device (105) of their own. This the Derivative Network Controller (130) is the means for the user to link up with other users in a shared learning experience. The Derivative Network Controller (130) controls auto creation, linkage, growth, security, maintenance and dissolution of all networks with a derivative structure.

Example of a Derivative Network Structure

A network with a derivative structure is one where a single network is escalated to chains of affinity networks spread across geographical regions within a city, state, country or the world. These affinity networks may have multiple unique attributes in common. The Derivative Network Controller (130) triggers a derivative component as soon as some criteria are met in the course of setting up a new network namely: topic/subject, grade/professional level, course materials/textbooks etc. The Derivative Network Controller (130) ensures that any additional network created is automatically linked to the predicate, no matter the region in the world where it was created. By creating a common chain link, collaboration is made possible across the multiple layers of networks with shared interests. Such multiple layers include, for example, a Primary Network, and Extended Primary Network, a Secondary Network, a Tertiary Network and a Global Network. Each individual network begins with the individual user having access to both the Discrete Learning Engine Device (105) as well as the Specially-Programmed Artificial Intelligence Computer (110). The Derivative Network Controller (130) is an integral component of the Specially-Programmed Artificial Intelligence Computer (110).

Collaboration in multi-layered engagement networks ranges from engagements between students and teachers, as well as professionals in for-profit as well as non-profit organizations. The primary goal is to facilitate learning and knowledge sharing. Each network is defined by its unique human members and their shared interests around topics or subjects they intend to learn or collaborate on, common course or training materials directly or indirectly related to the topics/subjects and their shared educational grade or professional levels. Overall, the collaboration network ecosystem is preferably driven by: network participants; a digital learning system provider; an artificial intelligence system provider; an internet service provider; and a cloud computing service provider as well as educational and non-educational institutions driving learning engagement.

An ARM Patterns (220) limitation requires that the Discrete Learning Engine Device (105) is further configured to engage the Activity Risk Monitor (115) after the Discrete Learning Engine Device (105) has been activated. The Activity Risk Monitor (115) resides on the Specially-Programmed Artificial Intelligence Computer (110). The Activity Risk Monitor (115) is configured to identify patterns found in use of the learning resources embedded in the Discrete Learning Engine Device (105). The patterns arise when multiple users experience the same learning issues or have similar interactions with the Discrete Learning Engine Device (105). The Activity Risk Monitor (115) recognizes these patterns.

The Activity Risk Monitor (115) supports surveillance of the individual user's learning activities as well as those of network participants to identify patterns that may expose the individual's or participants' risk of failure to attain their goals in their engagement in human to human or human to system learning activities. These goals may range from attaining higher proficiency in a topic/subject to ranking higher than other participants in a competition. For example, a network participant interested in learning a topic/subject may be required to submit to a diagnostic test to assess their level of proficiency. The result may indicate a low, medium or high risk of failure in their quest for learning the topic/subject considering all qualitative and quantitative factors. The participant may elect to define a goal to help in the learning journey. Subsequent network participant actions recorded may reveal compliance or deviation from goal. The Activity Risk Monitor (115) tracks any risks with non-compliance and further supports remediation steps.

By collecting data from large number of individuals and network participants, the Activity Risk Monitor quickly learns patterns and can deploy appropriate remediation steps if adverse trends are identified. Through massive data generated by massive number of network participants over an extended time horizon, the Activity Risk Monitor (115) develops and maintains a risk detection, predictive and remediation capacity that is supported by the Specially-Programmed Artificial Intelligence Computer (110). The Activity Risk Monitor (115) is an integral component of the Specially-Programmed Artificial Intelligence Computer (110).

An IPM Product (225) limitation requires that the Discrete Learning Engine Device (105) is further configured to enable use of an Integrated Publication Manager (120) after the Discrete Learning Engine Device (105) has been activated. The Integrated Publication Manager (120) resides on the Specially-Programmed Artificial Intelligence Computer (110). The Integrated Publication Manager (120) is configured to derive a conclusion from work by the user with the learning resources embedded in the Discrete Learning Engine Device (105). The Integrated Publication Manager (120) limitation is further configured to enable any of the one or more user computers (135) linked by the Derivative Network Controller (130) to print this conclusion.

Integrated Publication Manager (120) supports the capture, organization, review and eventual physical publication of critical learning activities derived from both individual and network learning activities. The Dynamic Response Optimization Module (125) passes critical learning assets worthy of documentation and eventual publication into physical text books or other academic materials to the Integrated Publication Manager (120). For example, if the Discrete Learning Engine Device (105) contains three different ways of solving a math problem; if an individual or a network of individuals develop a fourth or fifth method of solving the same problem, the Discrete Learning Engine Device (105) captures this new method or methods and the Dynamic Response Optimization Module (125) sends the same information to be captured in the Integrated Publication Manager (120). Then, the Integrated Publication Manager (120) aggregates and eventually distributes critical learning assets for processing at a printing press in the form of a text book that includes the new ways of solving the math problem.

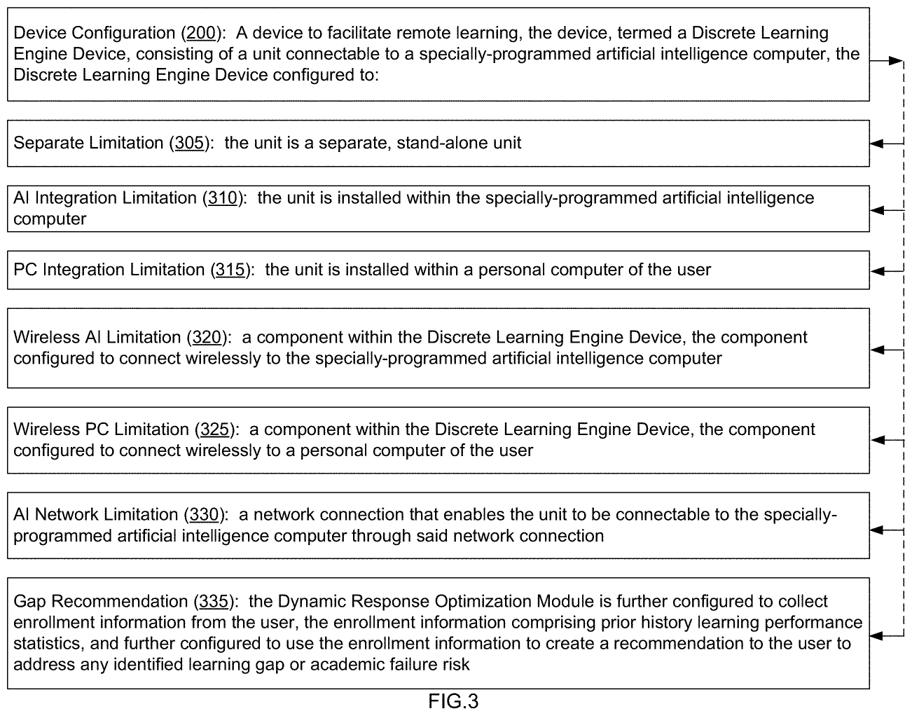

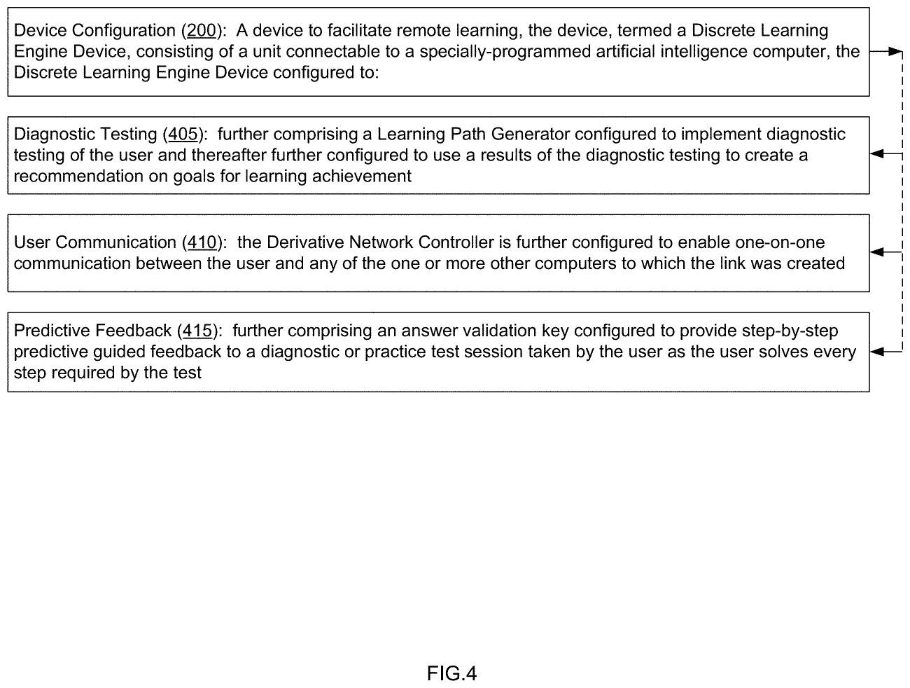

FIGS. 3 and 4 describe optional limitations for the Discrete Learning Engine Device (105). The connecting lines in these figures are used to designate optional steps.

In FIG. 3, an optional Separate Limitation (305) requires that the unit is a separate, stand-alone unit. Such a separate, stand-alone unit can be carried to different locations and then be connected up to any available computer with a wireless connection or, for example, a wired connection using a USB connection port commonly available on most computers today.

An optional AI Integration Limitation (310) requires that the unit is installed within the Specially-Programmed Artificial Intelligence Computer (110). When the user has a Specially-Programmed Artificial Intelligence Computer (110) of his/her own, the Discrete Learning Engine Device (105) may be installed within that computer and be more convenient for immediate access by the user.

An optional PC Integration Limitation (315) requires that the unit is installed within a personal computer of the user. This limitation makes it easier for the user of a single personal computer to immediately access and use the Discrete Learning Engine Device (105).

An optional Wireless AI Limitation (320) adds a component within the Discrete Learning Engine Device (105), which is within the Specially-Programmed Artificial Intelligence Computer (110). This component is configured to connect wirelessly to the Specially-Programmed Artificial Intelligence Computer (110). For this configuration, for example, a component adding BLUETOOTH capability would permit the Discrete Learning Engine Device (105) to connect with the Specially-Programmed Artificial Intelligence Computer (110) without a wired connection.

An optional Wireless PC Limitation (325) adds a component within the Discrete Learning Engine Device (105), which is within the Specially-Programmed Artificial Intelligence Computer (110). This component is configured to connect wirelessly to a personal computer of the user. For this configuration, for example, a component adding BLUETOOTH capability would permit the Discrete Learning Engine Device (105) to connect with the user's personal computer without a wired connection.

An optional AI Network Limitation (330) adds a network connection to the Discrete Learning Engine Device (105). This limitation enables the unit to be connectable to the Specially-Programmed Artificial Intelligence Computer (110) through said network connection.

An optional Gap Recommendation (335) limitation requires that the Dynamic Response Optimization Module (125), which is within the Specially-Programmed Artificial Intelligence Computer (110), is further configured to collect enrollment information from the user. This enrollment information includes prior history learning performance statistics for the user. The Dynamic Response Optimization Module (125) is further configured to use this enrollment information to create a recommendation to the user to address any identified learning gap or academic failure risk. The Dynamic Response Optimization Module (125) essentially evaluates the available information to create a unique recommendation on how to improve learning for a particular user.

Example of Enrollment Information Collection

The Specially-Programmed Artificial Intelligence Computer (110) may receive participant enrollment information from a Student Information System (SIS) and a Human Capital Management (HCM) system through initiation of enrollment process by the Dynamic Response Optimization Module (125). As a first step, a participant, whether a student, teacher or school administrator, submits vital information requested by school that is captured by the SIS/HCM systems as part of the onboarding process. The Dynamic Response Optimization Module (125) automatically retrieves participant information through connection to the SIS/HCM systems. Then, an invitation is sent to the participant to enroll in the Discrete Learning Engine Device program. Once participant accepts invitation, they are instantly enrolled in the Discrete Learning Engine Device program. The digital learning systems provider then receives a subscription to buy the Discrete Learning Engine Device (105) from the user. After the request is processed, the Discrete Learning Engine Device (105) is then physically delivered to the student for use in advancing personalized learning and sharing, and collaboration with peers.

In FIG. 4, an optional Diagnostic Testing (405) limitation requires that the Learning Path Generator (1905), which is within the Discrete Learning Engine Device (105), is further configured to implement diagnostic testing of the user and thereafter further configured to use a results of the diagnostic testing to create a recommendation on goals for learning achievement. The Learning Path Generator (1905) creates a recommended learning agenda for the user to address needed inadequate knowledge or understanding of the user identified though the diagnostic testing.

An optional User Communication (410) limitation requires that the Derivative Network Controller (130), which is within the Specially-Programmed Artificial Intelligence Computer (110), is further configured to enable one-on-one communication between the user and any of the one or more other computers to which the link was created.

An optional Predictive Feedback (415) limitation requires that the Discrete Learning Engine Device (105) include an answer validation key. The answer validation key is a program that provides real-time, step-by-step predictive guided feedback from a diagnostic or practice test session taken by the user as the user solves every step required by the test.

Example of Using the Discrete Learning Engine Device

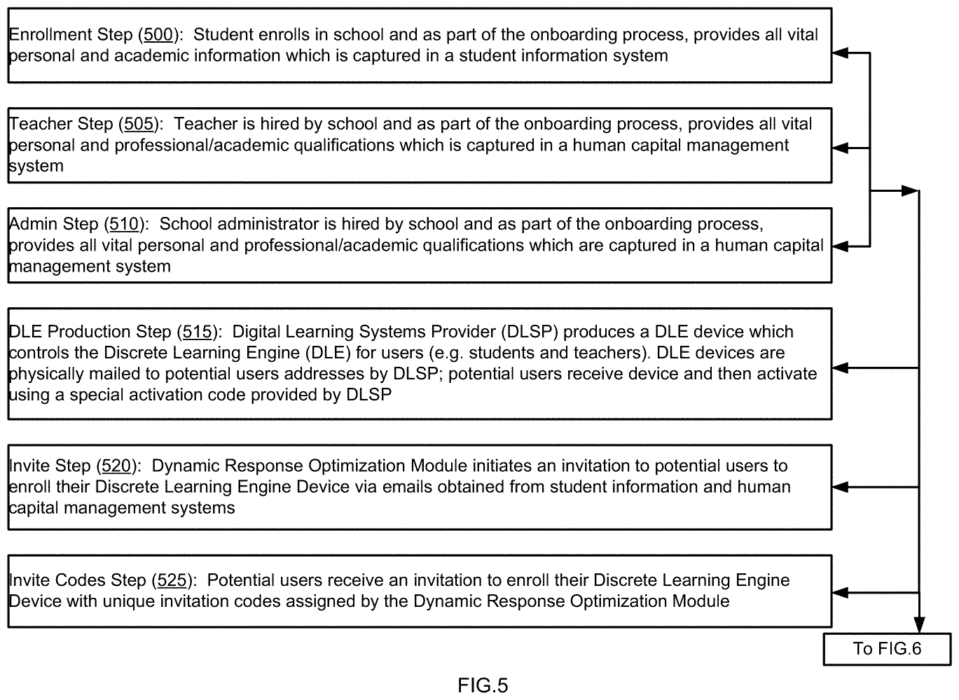

FIGS. 5-17 illustrate a method of using the Discrete Learning Engine Device (105).

FIG. 5 explains five initial steps in this example: An Enrollment Step (500); a Teacher Step (505); an Admin Step (510); a DLE Production Step (515); and an Invite Step (520).

The exemplary steps begin with the Enrollment Step (500) in which a student enrolls in school and as part of the onboarding process. The student provides all vital personal and academic information which is captured in a student information system.

The Teacher Step (505) is begun when a teacher is hired by the school and as part of the onboarding process. This process records the vital personal and professional/academic qualifications of the teacher, which are solicited from the teacher and captured in a human capital management system.

The Admin Step (510) is begun when a school administrator is hired by the school and as part of the onboarding process. This process records the vital personal and professional/academic qualifications of the school administrator, which are solicited from the school administrator and captured in a human capital management system.

The DLE Production Step (515) is begun when the Digital Learning Systems Provider (DLSP) produces the Discrete Learning Engine Device (105). The Discrete Learning Engine Device (105) is configured to control the Discrete Learning Engine (DLE) for users (e.g. students and teachers). The Discrete Learning Engine Device (105) is physically delivered to each user using the user's address previously collected by Digital Learning Systems Provider. Once a user receives the device, it can be activated using a special activation code provided by Digital Learning Systems Provider.

The Invite Step (520) is begun when the Dynamic Response Optimization Module (125) initiates an invitation to potential users to enroll their Discrete Learning Engine Device (105) via emails obtained from student information and human capital management systems.

The Invite Codes Step (525) occurs when potential users receive an invitation to enroll their Discrete Learning Engine Device (105) with unique invitation codes assigned by the Dynamic Response Optimization Module (125).

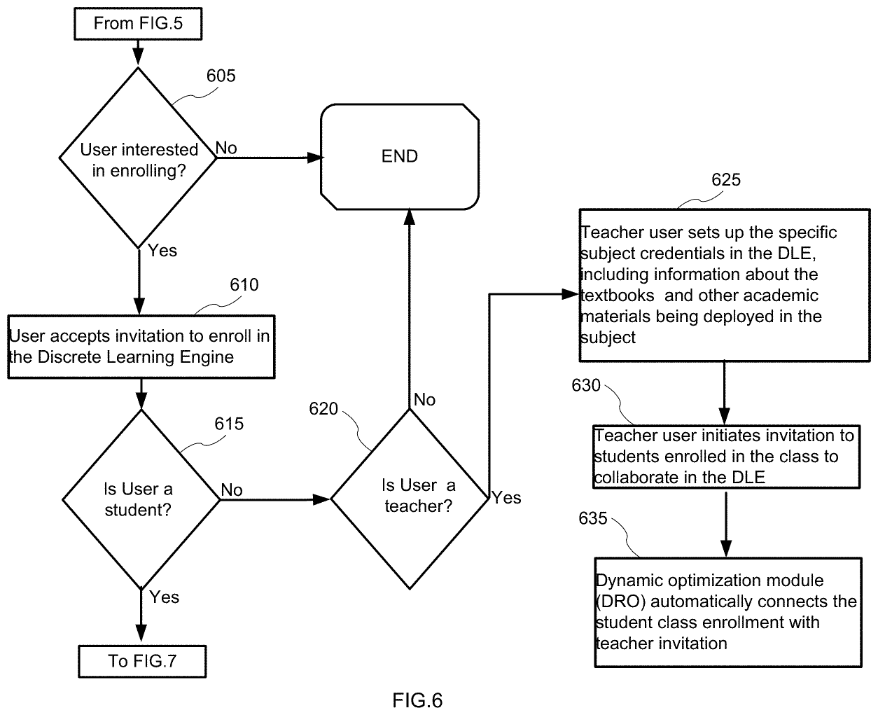

FIG. 6 illustrates and continues the process with a determination about whether or not the user is interested in enrolling (605), which is confirmed when the user accepts invitation to enroll in the Discrete Learning Engine (610).

The next step determines if the user is a student (615) or if the user is a teacher (620). If the user is a teacher, the teacher-user (625) sets up the specific subject credentials in the Discrete Learning Engine Device (105), including information about the textbooks and other academic materials being deployed in the subject. The teacher-user then initiates an invitation (630) to students enrolled in the class to collaborate through the Discrete Learning Engine Device (105). For those who accept the invitation, the Dynamic Response Optimization Module (125) automatically connects (635) the student class enrollment with teacher invitation.

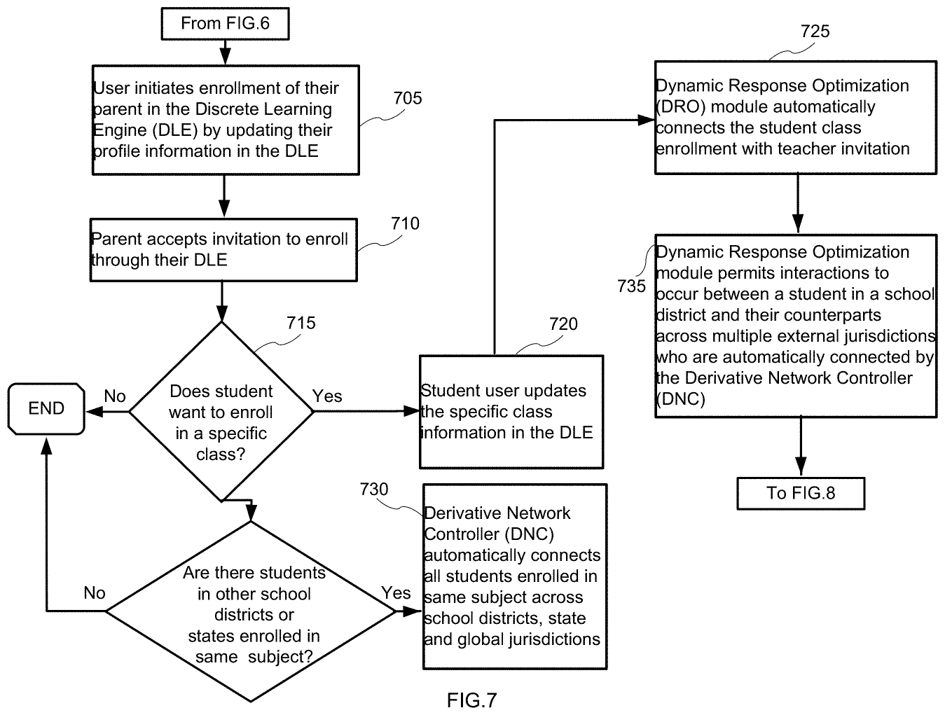

FIG. 7 continues the step-wise illustration of the method of using the Discrete Learning Engine Device (105).

Once the invitation is accepted, the user, who is typically a student, initiates enrollment (705) of their parent in the Discrete Learning Engine Device (105) by updating their profile information in the Discrete Learning Engine Device (105). Then, the parent (710) accepts the invitation to enroll through their Discrete Learning Engine Device (105), which asks if the student wants to enroll (715) in a specific class? If not, the interaction with that user ends. If so, then the Discrete Learning Engine Device (105) permits the student user to update (720) the specific class information in the Discrete Learning Engine Device (105). Once updated, the Dynamic Response Optimization Module (125) automatically connects the student class enrollment with the teacher invitation.

Example of User Profile Setup

The process of user profile set up in the Discrete Learning Engine Device (105) may depend on the user. For example, if the participant is a teacher, they are invited to create the full profile of the class they teach at the school. They may create an individual class network at the school (e.g. 10th grade Chemistry class at Crawford high school). The teacher further specifies the curriculum of the class as well as the textbooks and other academic materials to be used in the class. Additionally, the teacher is able to invite their students to the class network to collaborate and learn. If they choose to invite students, the students are required to accept the invitation to join the aforementioned class network.

If another teacher teaches the same 10th grade Chemistry class at a different school with the same curriculum and textbooks/academic materials, once they have set up their profile in the Discrete Learning Engine Device (105), they are automatically connected by the Derivative Network Controller (130) to all teachers teaching the same subject with same curriculum and text books/academic materials. If another teacher invites their students to the class's network, those students are automatically connected to their peers at the previously mentioned school as well. This process of profile and network set up at the individual school level is amplified through further connection of participants with identical Discrete Learning Engine Devices, class curriculum, text books and academic materials at the school district level, state/regional level, national level and global level.

Even if the student responds to the invitation and declines to enroll, the Discrete Learning Engine Device (105) determines (725) if there are students in other school districts or states enrolled in same subject. If there is at least one other student enrolled, then the Derivative Network Controller (130) automatically connects (730) all students enrolled in same subject across school districts, state and global jurisdictions. Once connected, the Dynamic Response Optimization Module (125) permits interactions (735) to occur between a student in a school district and their counterparts across multiple external jurisdictions who are automatically connected by the Derivative Network Controller (130).

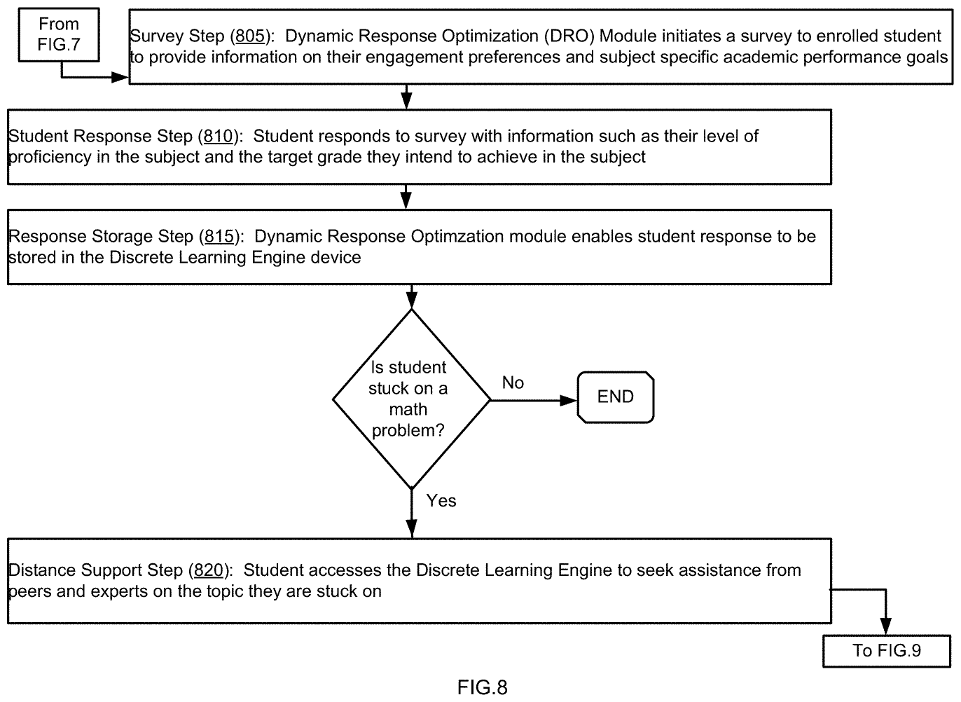

FIG. 8 continues the step-wise illustration of the method of using the Discrete Learning Engine Device (105).

A Survey Step (805) requires the Dynamic Response Optimization Module (125) to send a survey to each enrolled student to provide information on their engagement preferences and subject specific academic performance goals. This is followed by a Student Response Step (810) where the student responds to survey with information such as their level of proficiency in the subject and the target grade they intend to achieve in the subject. Then, a Response Storage Step (815) activates the Dynamic Response Optimization Module (125) to store the student response in the Discrete Learning Engine Device (105) associated with that student. Should a student subsequently be stuck on a math problem, then in a Distance Support Step (820), the student may have access to the Discrete Learning Engine Device (105) to seek assistance from peers and experts on the topic they are stuck on.

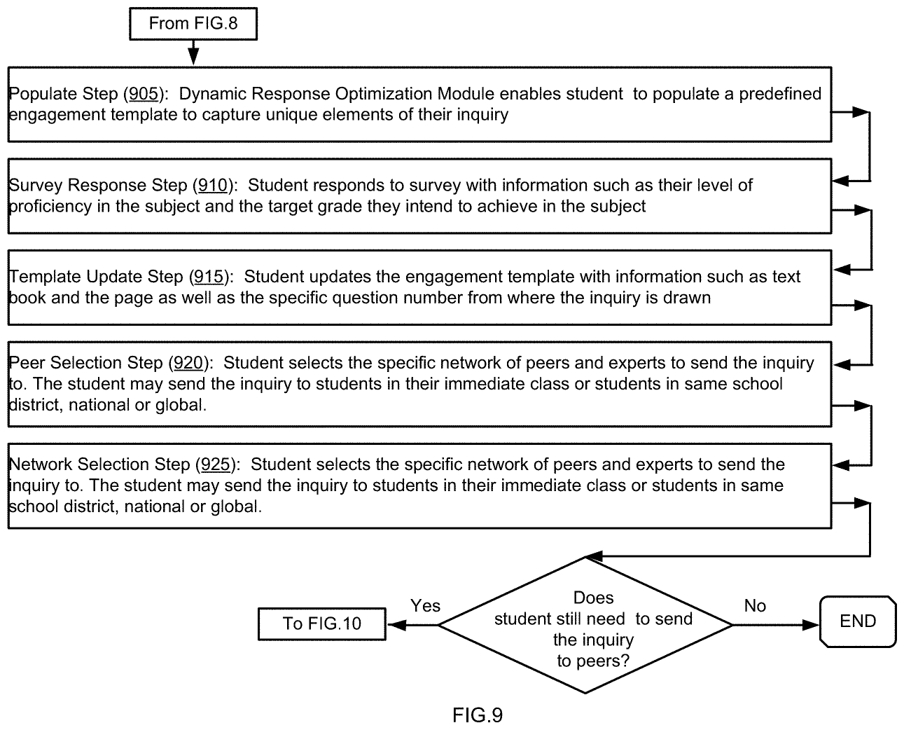

FIG. 9 continues the step-wise discussion of the method of using the Discrete Learning Engine Device (105) and illustrates collaboration in such use.

A Populate Step (905) explains that the Dynamic Response Optimization Module (125) enables the student to populate a predefined engagement template to capture unique elements of their inquiry. Then, a Survey Response Step (910) captures a student response to the survey with information such as their level of proficiency in the subject and the target grade they intend to achieve in the subject. Then, in the Template Update Step (915), the student updates the engagement template with information such as text book and the page as well as the specific question number from where the inquiry is drawn. This is followed by a Peer Selection Step (920) in which the student selects the specific network of peers and experts to send the inquiry to. The student may send the inquiry to students in their immediate class or students in same school district, national or global. This is followed by a Network Selection Step (925) in which the student selects the specific network of peers and experts to send the inquiry to. The student may send the inquiry to students in their immediate class or students in same school district, national or global. When the student no longer needs to send the inquiry, the Dynamic Response Optimization Module (125) stops the collaboration process. If however, the student still has an inquiry for his peers, then the Dynamic Response Optimization Module (125) would continue the collaboration process.

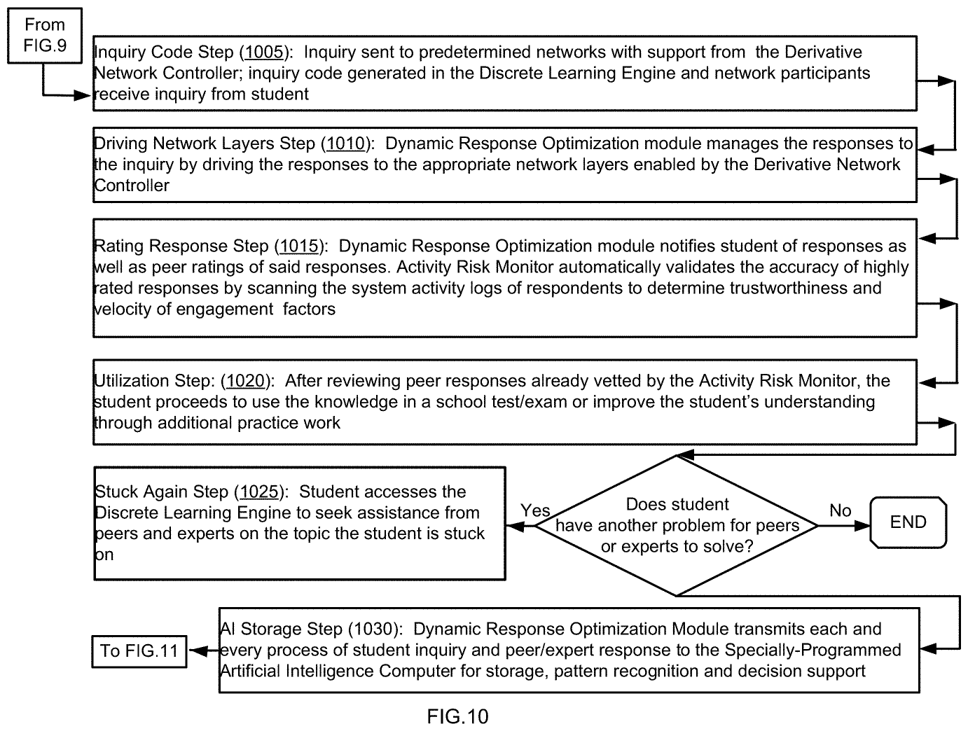

FIG. 10 continues the collaboration process description in the method of using the Discrete Learning Engine Device (105).

An Inquiry Code Step (1005) teaches that an inquiry may be sent to predetermined networks with support from the Derivative Network Controller (130) where the inquiry code is generated in the Discrete Learning Engine Device (105) and network participants receive the inquiry from the student. This is followed by a Driving Network Layers Step (1010) in which the Dynamic Response Optimization Module (125) manages the responses to the inquiry by driving the responses to the appropriate network layers enabled by the Derivative Network Controller (130). Then, in a Rating Response Step (1015), the Dynamic Response Optimization Module (125) notifies the student of responses as well as peer ratings of said responses. Activity Risk Monitor (115) automatically validates the accuracy of highly-rated responses by scanning the system activity logs of respondents to determine trustworthiness and velocity of engagement factors. Then, in a Utilization Step (1020), after reviewing peer responses already vetted by the Activity Risk Monitor (115), the student proceeds to use the knowledge in a school test/exam or improve the student's understanding through additional practice work. If the student has another problem for peers or experts to solve, then in a Stuck Again Step (1025), the student accesses the Discrete Learning Engine Device (105) to seek assistance from peers and experts on the topic the student is stuck on. A preferred step in the process is an AI Storage Step (1030) in which the Dynamic Response Optimization Module (125) transmits each and every process of student inquiry and peer/expert response to the Specially-Programmed Artificial Intelligence Computer (110) for storage, pattern recognition and decision support.

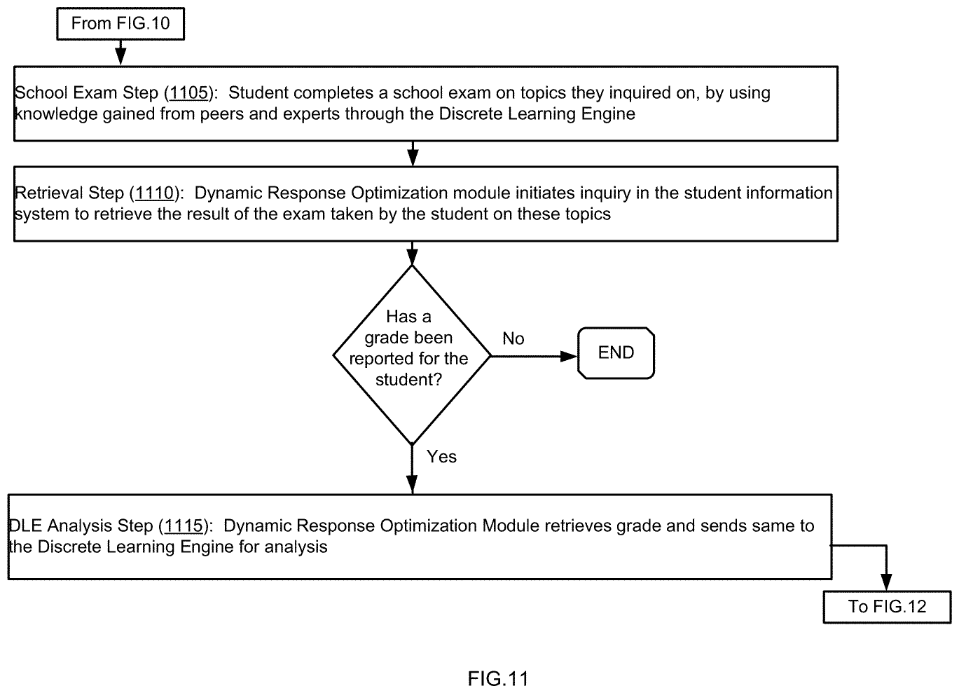

FIG. 11 continues the collaboration process description in the method of using the Discrete Learning Engine Device (105).

A School Exam Step (1105) explains that a student completes a school exam on topics they inquired on, by using knowledge gained from peers and experts through the Discrete Learning Engine Device (105). Then, in a Retrieval Step (1110), the Dynamic Response Optimization Module (125) initiates an inquiry in the student information system to retrieve the result of the exam taken by the student on these topics. Then, if a grade been reported for the student, DLE Analysis Step (1115), the Dynamic Response Optimization Module (125) retrieves the grade and sends same to the Discrete Learning Engine Device (105) for analysis.

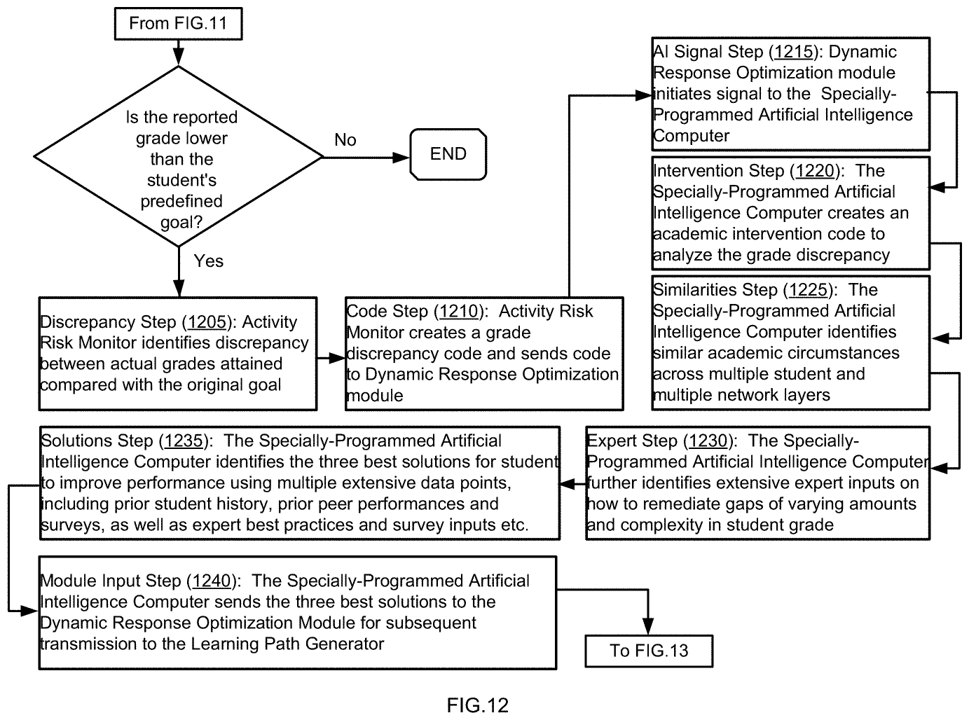

FIG. 12 continues the collaboration process description in the method of using the Discrete Learning Engine Device (105).

If the Dynamic Response Optimization Module (125) determines that the reported grade is lower than the student's predefined goal, then in a Discrepancy Step (1205), the Activity Risk Monitor (115) identifies discrepancy between actual grades attained compared with the original goal. Then, in a Code Step (1210), the Activity Risk Monitor (115) creates a grade discrepancy code and sends the code to Dynamic Response Optimization Module (125). Then in an AI Signal Step (1215), the Dynamic Response Optimization Module (125) initiates a signal to the Specially-Programmed Artificial Intelligence Computer (110). In response, in an Intervention Step (1220), the Specially-Programmed Artificial Intelligence Computer (110) creates an academic intervention code to analyze the grade discrepancy. In a Similarities Step (1225), the Specially-Programmed Artificial Intelligence Computer (110) then identifies similar academic circumstances across multiple student and multiple network layers. In addition, in an Expert Step (1230), the Specially-Programmed Artificial Intelligence Computer (110) identifies extensive expert inputs on how to remediate gaps of varying amounts and complexity in the student grade. In a Solutions Step (1235), the Specially-Programmed Artificial Intelligence Computer (110) identifies the three best solutions for the student to improve performance using multiple extensive data points, including prior student history, prior peer performances and surveys, as well as expert best practices and survey inputs etc. Then, in a Module Input Step (1240), the Specially-Programmed Artificial Intelligence Computer (110) sends the three best solutions to the Dynamic Response Optimization Module (125) for subsequent transmission to the Learning Path Generator.

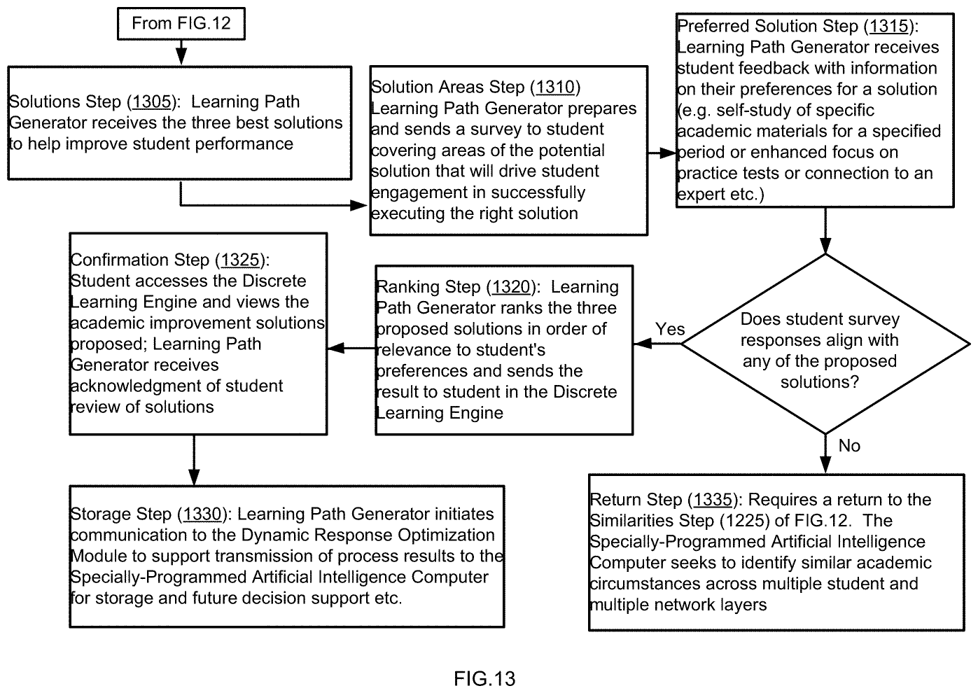

FIG. 13 continues the collaboration process description in the method of using the Discrete Learning Engine Device (105).

After the Learning Path Generator sends the three best solutions, a Solutions Step (1305) requires that the Learning Path Generator receive these three best solutions to help improve student performance. Then, a Solution Areas Step (1310) requires that the Learning Path Generator prepare and send a survey to the student covering areas of the potential solution that will drive student engagement in successfully executing the right solution. A Preferred Solution Step (1315) then requires that the Learning Path Generator receive the student feedback with information on their preferences for a solution (e.g. self-study of specific academic materials for a specified period or enhanced focus on practice tests or connection to an expert etc.). The Learning Path Generator then determines whether or not the student survey responses align with any of the proposed solutions. If so, then the Ranking Step (1320) requires that the Learning Path Generator rank the three proposed solutions in order of relevance to student's preferences and sends the result to student in the Discrete Learning Engine Device (105). Then, the Confirmation Step (1325) permits student accesses to the Discrete Learning Engine Device (105) and views the academic improvement solutions proposed. Once completed, the Learning Path Generator receives acknowledgment of the student's review of solutions. Then, the Storage Step (1330) requires that the Learning Path Generator initiate communication with the Dynamic Response Optimization Module (125) to support transmission of process results to the Specially-Programmed Artificial Intelligence Computer (110) for storage and future decision support, etc. If the student survey responses do not align with any of the proposed solutions, then the Return Step (1335) requires a return to the Similarities Step (1225) of FIG. 12 and resume the steps that follow the Similarities Step (1225). In the earlier step, the Specially-Programmed Artificial Intelligence Computer (110) seeks to identify similar academic circumstances across multiple student and multiple network layers.

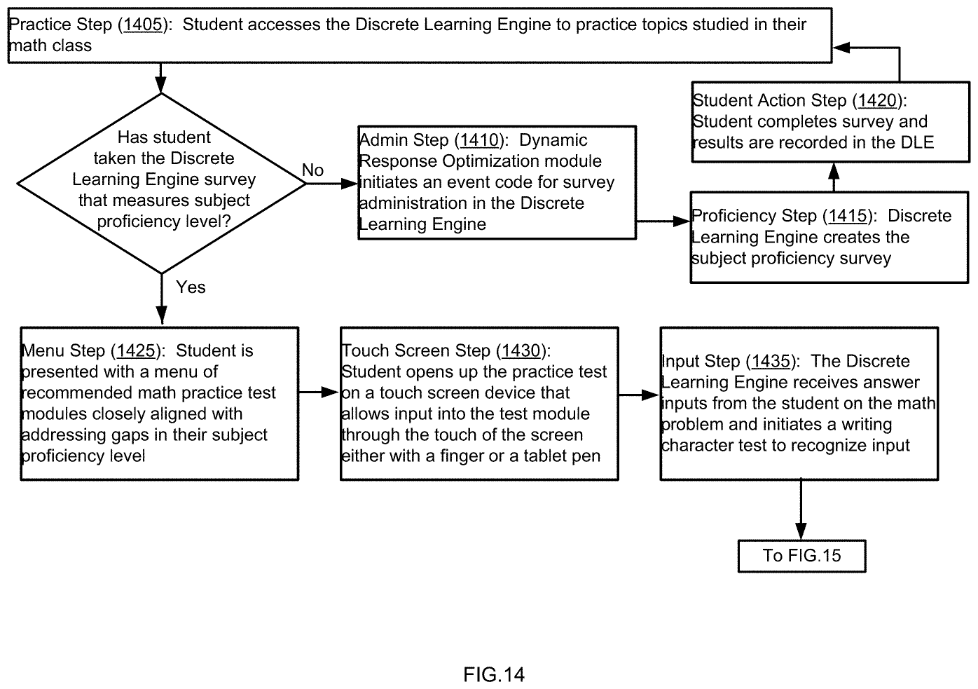

FIG. 14 continues the collaboration process description in the method of using the Discrete Learning Engine Device (105).

In Practice Step (1405), the student accesses the Discrete Learning Engine Device (105) to practice topics studied in their math class. If the student has not yet taken the Discrete Learning Engine Device (105) survey that measures subject proficiency level, then in an Admin Step (1410), the Dynamic Response Optimization Module (125) initiates an event code to initiate survey administration in the Discrete Learning Engine Device (105). As a result, in the Proficiency Step (1415), the Discrete Learning Engine Device (105) creates the subject proficiency survey. Then, in the Student Action Step (1420), the student completes the survey and results are recorded in the Discrete Learning Engine Device (105).

If the student has already taken the Discrete Learning Engine Device (105) survey that measures subject proficiency level, then in a Menu Step (1425), then the student is presented with a menu of recommended math practice test modules closely aligned with addressing gaps in their subject proficiency level. Then, the Touch Screen Step (1430) enables the student to open up the practice test on a touch screen device that allows input into the test module through the touch of the screen either with a finger or a tablet pen. This is followed by the Input Step (1435) where the Discrete Learning Engine Device (105) receives answer inputs from the student on the math problem and initiates a writing character test to recognize input.

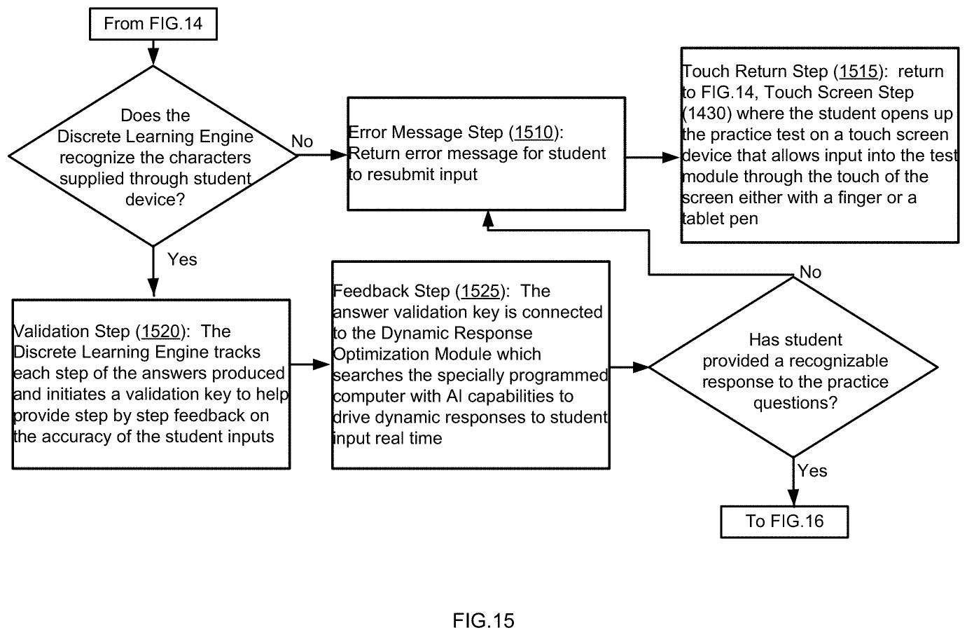

FIG. 15 continues the collaboration process description in the method of using the Discrete Learning Engine Device (105).

If the Discrete Learning Engine Device (105) does not recognize the characters supplied through the Discrete Learning Engine Device (105) operated by the student, then the Error Message Step (1510) is implemented wherein it returns an error message for the student to resubmit the student's input. Then, in the touch Return Step (1515) requires the process to return to FIG. 14, Touch Screen Step (1430) where the student again opens up the practice test on a touch screen device that allows input into the test module through the touch of the screen either with a finger or a tablet pen. The process then runs anew from that step.

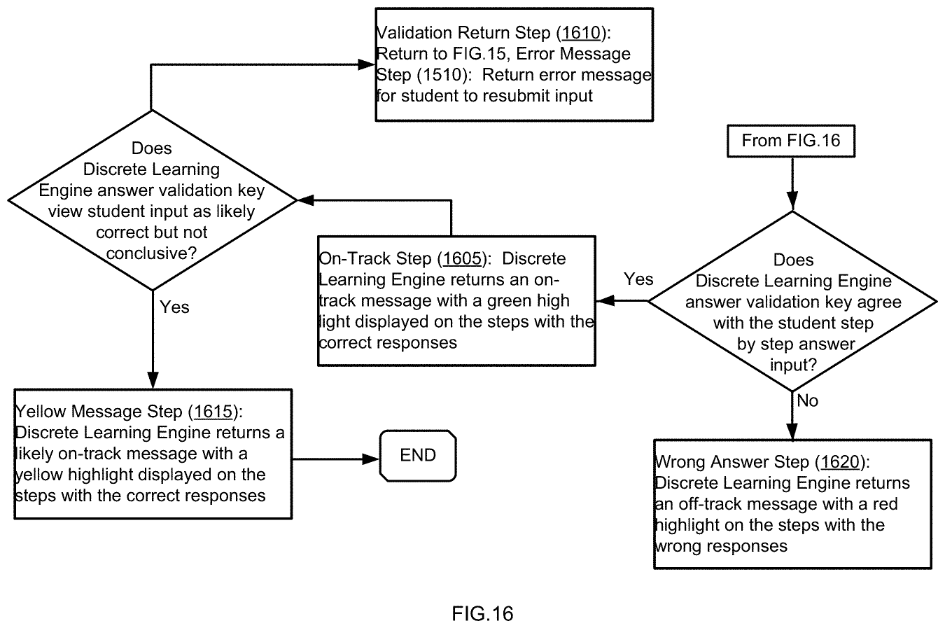

If the Discrete Learning Engine Device (105) recognizes the characters supplied by the student through the Discrete Learning Engine Device (105), then the Validation Step (1520) is implemented where the Discrete Learning Engine Device (105) tracks each step of the answers produced and initiates a validation key to help provide step by step feedback on the accuracy of the student inputs. Afterward, the Feedback Step (1525) is performed where the answer validation key is connected to the Dynamic Response Optimization Module (125) which searches the Specially-Programmed Artificial Intelligence Computer (110) to drive dynamic responses to the student input in real time. If the student has not provided a recognizable response to the practice questions, then an Error Message Step (1510) is performed which returns an error message asking the student to resubmit the input. If the student has provided a recognizable response to the practice questions, then the method proceeds to the next step in FIG. 16.

FIG. 16 continues the collaboration process description in the method of using the Discrete Learning Engine Device (105).

If the student has provided a recognizable response to the practice questions, then the Discrete Learning Engine Device (105) yields an answer validation key that indicates agreement with the student step by step answer input and continues with an On-Track Step (1605) where the Discrete Learning Engine Device (105) returns an on-track message with a green high light displayed on the steps with the correct responses.

When the Discrete Learning Engine Device (105) answer validation key views the student input as incorrect or not likely correct or not conclusive, then the Validation Return Step (1610) requires regression of steps with a Validation Return Step (1610), which requires a return to FIG. 15, Error Message Step (1510), which produces an error message for student to resubmit the input.

When the Discrete Learning Engine Device (105) answer validation key views the student input as likely correct but not conclusive, then the Yellow Message Step (1615) requires the Discrete Learning Engine Device (105) to return a likely on-track message with a yellow highlight displayed on the steps with the correct but not conclusively so responses. This ends the test results. If however, the Discrete Learning Engine Device (105) answer validation key indicates disagreement with any of the student step by step answer input, then the Wrong Answer Step (1620) requires the Discrete Learning Engine Device (105) to return an off-track message with a red highlight on the steps with the wrong responses.

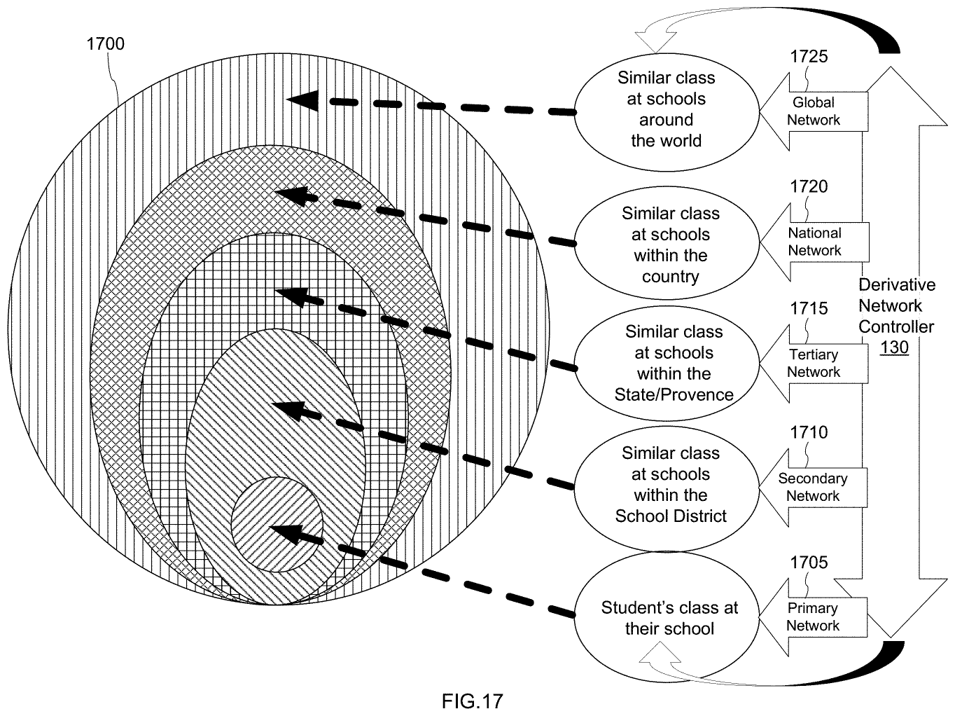

FIG. 17 is an illustration of the potential users of the Discrete Learning Engine Device (105) in the context of possible networks connecting those users.

The Discrete Learning Engine Device (105) is part of an automated system that enables the Derivative Network Controller (130) with its multi layered engagement network structure (1700). The specific layers that make up the ecosystem of multi layered engagement network structure (1700) begin with the primary network (1705), secondary network (1710), tertiary network (1715), national network (1720) and global network (1725). The networks are woven together from individual class networks established by users and are joined together to form a continuous loop of affiliated networks distinguished by unique characteristics.

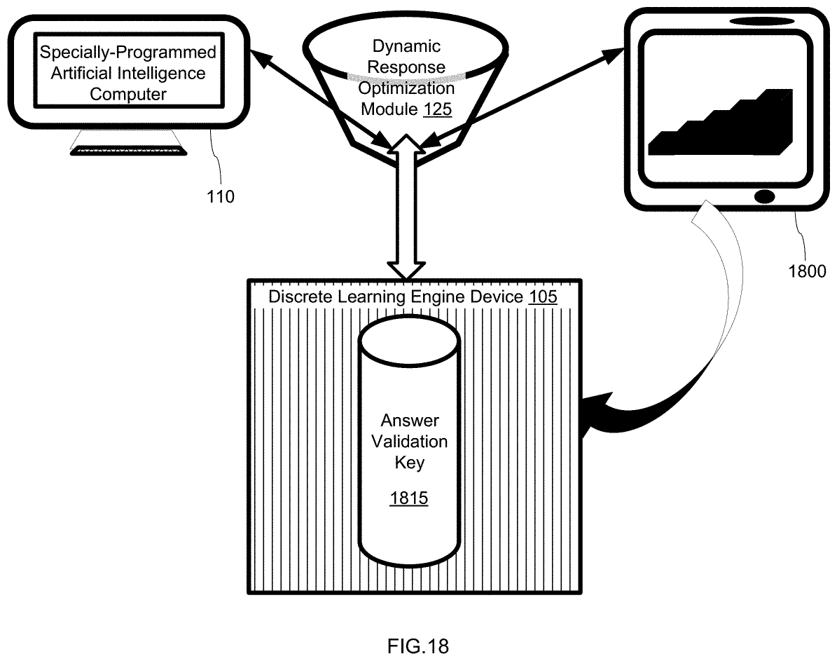

FIG. 18 is an illustration of the interaction of components of the Discrete Learning Engine Device (105) as part of the automated system that supports connection to a mobile device (1800) and a Discrete Learning Engine Device (105) with an Answer Validation Key in (1815). The Dynamic Response Optimization Module (125) is the process manager of the activities occurring between the Specially-Programmed Artificial Intelligence Computer (110) and the Discrete Learning Engine Device (105). The Dynamic Response Optimization Module (125) connects all interactions between these systems in (1805), controlled by the Specially-Programmed Artificial Intelligence Computer (110).

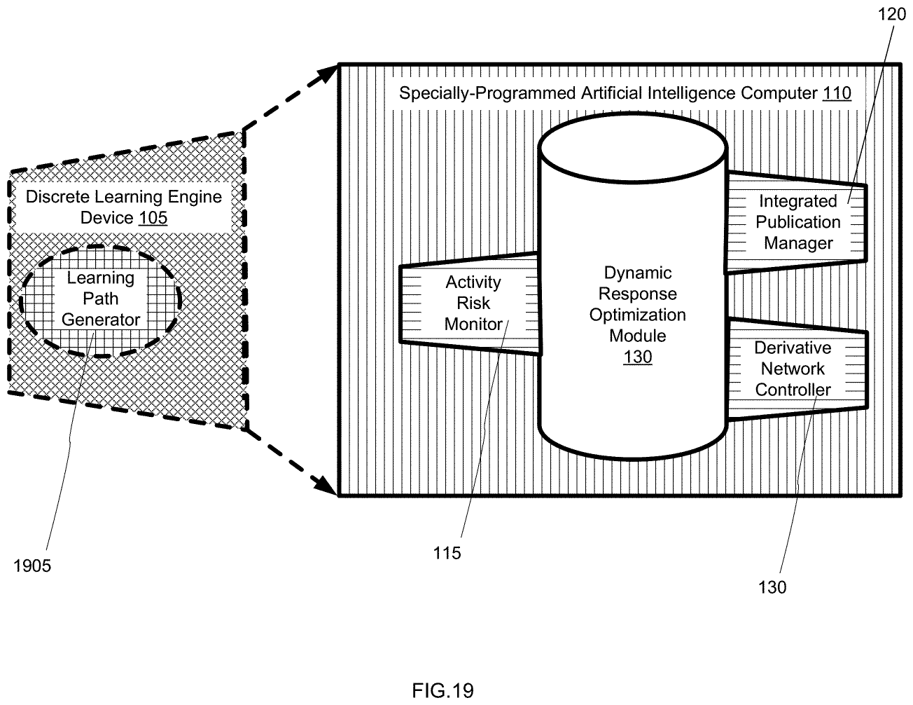

FIG. 19 is an illustration of the interaction of preferred components of the Discrete Learning Engine Device (105), which is part of the automated system. The automated system includes the Derivative Network Controller (130), Activity Risk Monitor (115), Integrated Publication Manager (120), and the Dynamic Response Optimization Module (125). The Discrete Learning Engine Device (105) interacts with these components to effectively integrate their operation.

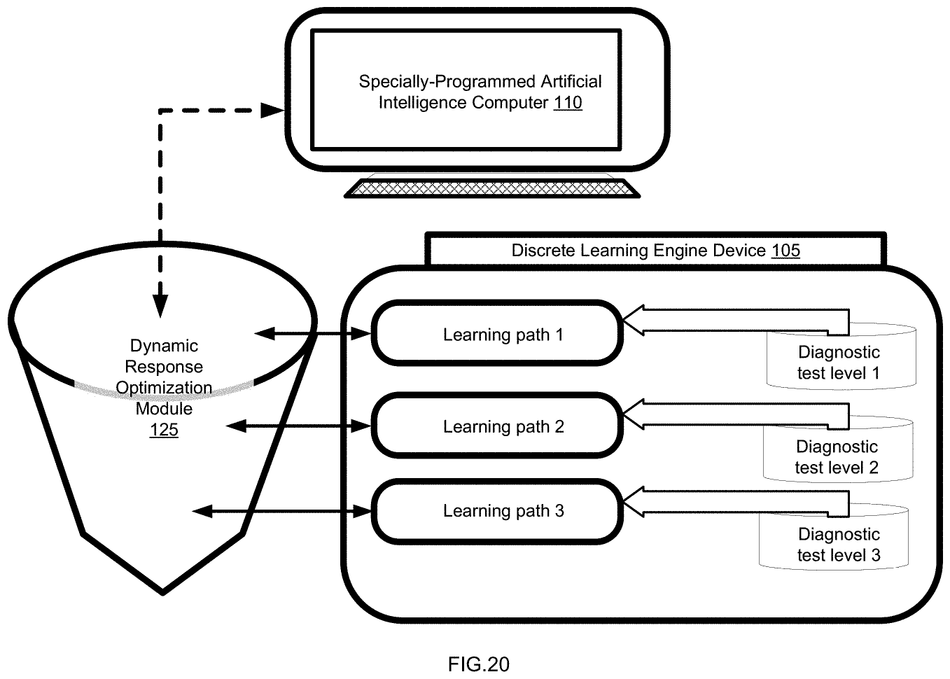

FIG. 20 is an illustration of the interaction of components of the Discrete Learning Engine Device (105). The Discrete Learning Engine Device (105) supports the administration of diagnostic tests. The Dynamic Response Optimization Module (125) facilitates the administration of the tests by connecting the actions of the Discrete Learning Engine Device (105) with the Specially-Programmed Artificial Intelligence Computer (110). Multiple learning paths are established to account for differences in learning style and to further enhance personalized learning.

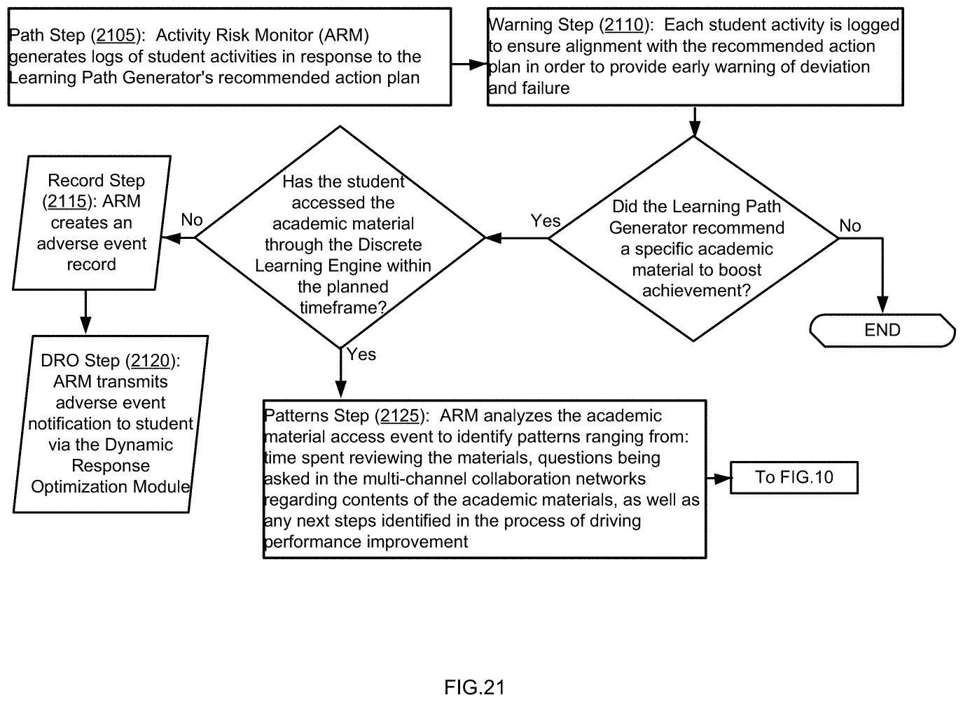

FIG. 21 is a flow diagram of utilization actions of the Activity Risk Monitor (115), which supports the surveillance of network activities to identify patterns that may expose participants' risk of failure to attain their goals in their engagement in human to human or human to system activities.

The Path Step (2105) requires the Activity Risk Monitor (115) to generate logs of student activities in response to a recommended action plan formulated by the Learning Path Generator (1905). In a Warning Step (2110), each student activity is logged to ensure alignment with the recommended action plan in order to provide early warning of deviation and failure. If the recommended action plan formulated by the Learning Path Generator (1905) boosted achievement, and if the student accessed the academic material through the Discrete Learning Engine Device (105) within the planned timeframe, then, in a Patterns Step (2125), the Activity Risk Monitor (115) analyzes the academic material access event to identify patterns ranging from: time spent reviewing the materials, questions being asked in the multi-channel collaboration networks regarding contents of the academic materials, as well as any next steps identified in the process of driving performance improvement. If the student did not access the material in the planned timeframe, then in a Record Step (2115), the Activity Risk Monitor (115) creates an adverse event record. Then, in a DRO Step (2120), transmits an adverse event notification to student via the Dynamic Response Optimization Module (125).

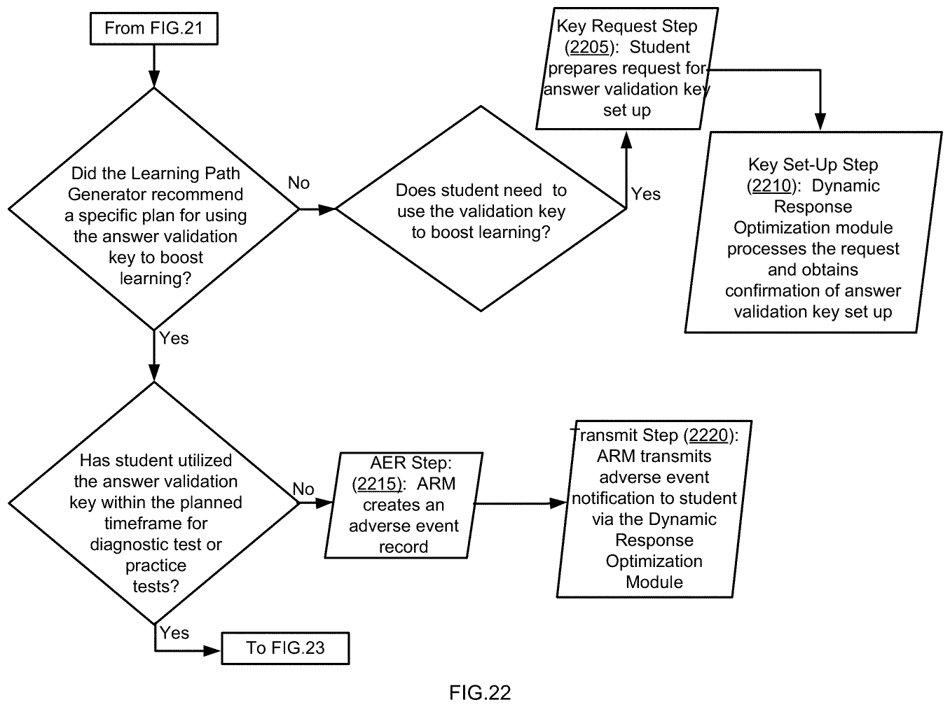

FIG. 22 continues the steps from FIG. 21 with additional utilization actions of the Activity Risk Monitor (115).

When the Learning Path Generator (1905) recommends a specific plan for using the answer validation key to boost learning and when the student needs to use the validation key to boost learning, then in a Key Request Step (2205), the student prepares a request for answer validation key set up. In a Key Set-Up Step (2210), the Dynamic Response Optimization Module (125) processes the request and obtains confirmation of answer validation key set up.

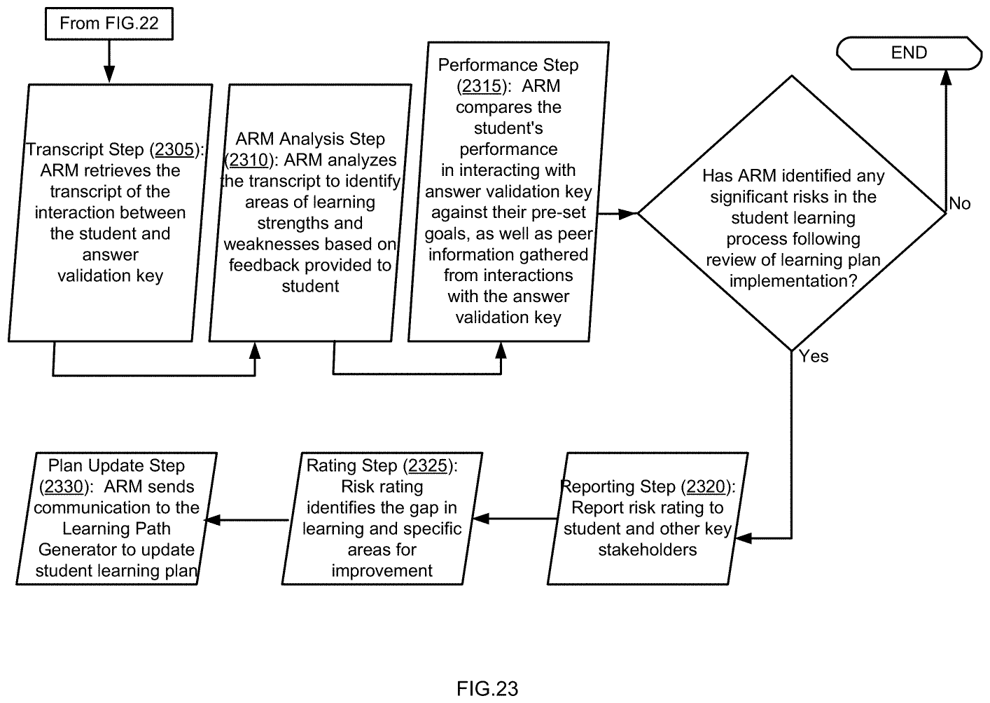

When the Learning Path Generator (1905) recommends a specific plan for using the answer validation key to boost learning, and if the student has not utilized the answer validation key within the planned timeframe for diagnostic test or practice tests, then in an AER Step: (2215), the Activity Risk Monitor (115) creates an adverse event record. Then in a Transmit Step (2220), the Activity Risk Monitor (115) transmits an adverse event notification to student via the Dynamic Response Optimization Module (125). On the other hand if the student utilized the answer validation key within the planned timeframe for diagnostic test or practice tests, then the process continues in a Transcript Step (2305) in FIG. 23.

In the Transcript Step (2305), the Activity Risk Monitor (115) retrieves the transcript of the interaction between the student and the answer validation key. Then, in an ARM Analysis Step (2310), the Activity Risk Monitor (115) analyzes the transcript to identify areas of learning strengths and weaknesses based on feedback provided to student. Then in a Performance Step (2315), the Activity Risk Monitor (115) compares the student's performance in interacting with answer validation key against their pre-set goals, as well as peer information gathered from interactions with the answer validation key. When the Activity Risk Monitor (115) identifies a significant risk in the student learning process following review of learning plan implementation, a Reporting Step (2320) is implemented and the Activity Risk Monitor (115) reports the risk rating to the student and other key stakeholders. Then, a Rating Step (2325) is implemented wherein the Activity Risk Monitor (115) assess a risk rating and identifies the gap in learning and specific areas for improvement. Afterwards, a Plan Update Step (2330) is implemented and the Activity Risk Monitor (115) sends a communication to the Learning Path Generator (1905) to update the student learning plan.

When the Activity Risk Monitor (115) cannot identify a significant risk in the student learning process following review of learning plan implementation, then the process ends.

Example Regarding the Activity Risk Monitor (115)

As an example, the student goals in their engagement in human to human or human to system activities may range from attaining higher proficiency in a topic/subject to ranking higher than other participants in a competition. For example, a network participant interested in learning a topic/subject may be required to submit to a diagnostic test to assess their level of proficiency. The result may indicate a low, medium or high risk of failure in their quest for learning the topic/subject considering all qualitative and quantitative factors. The participant may elect to define a goal to help in the learning journey. Subsequent network participant actions recorded may reveal compliance or deviation from goal.

The Activity Risk Monitor (115) tracks any risks of non-compliance and further supports remediation steps. By collecting data from large number of network participants, the Activity Risk Monitor (115) quickly learns patterns and can deploy appropriate remediation if adverse trends have been identified. Through massive data generated by massive number of network participants over an extended time horizon, the Activity Risk Monitor (115) develops and maintains a risk detection, predictive and remediation capacity that reflects an element of Artificial Intelligence.

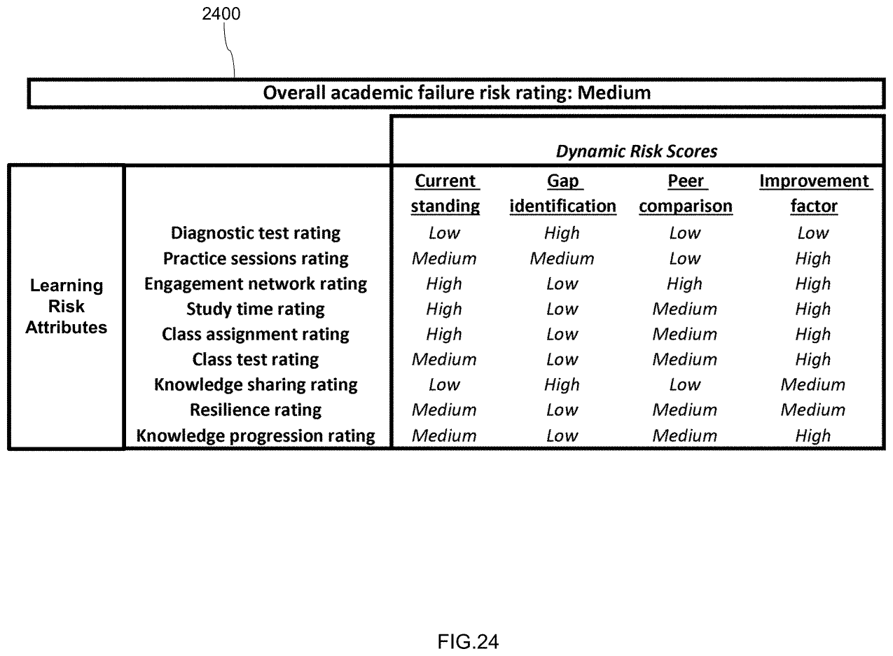

FIG. 24 is an illustration of a report generated in utilizing the Activity Risk Monitor (115). The Activity Risk Monitor (115) generates a range of risk scores to measure user performance and mitigate failure. A risk analysis matrix (2400), provides an example of how the Activity Risk Monitor (115) would rate a student's chances of overcoming learning challenges based on a diverse set of risk attributes. For example, if the student has a low rating in their current standing in taking diagnostic tests, but are medium or high in a many other risk attributes, their risk of academic failure may be medium risk. The Activity Risk Monitor (115) measures risks in terms of low, medium and high factors.

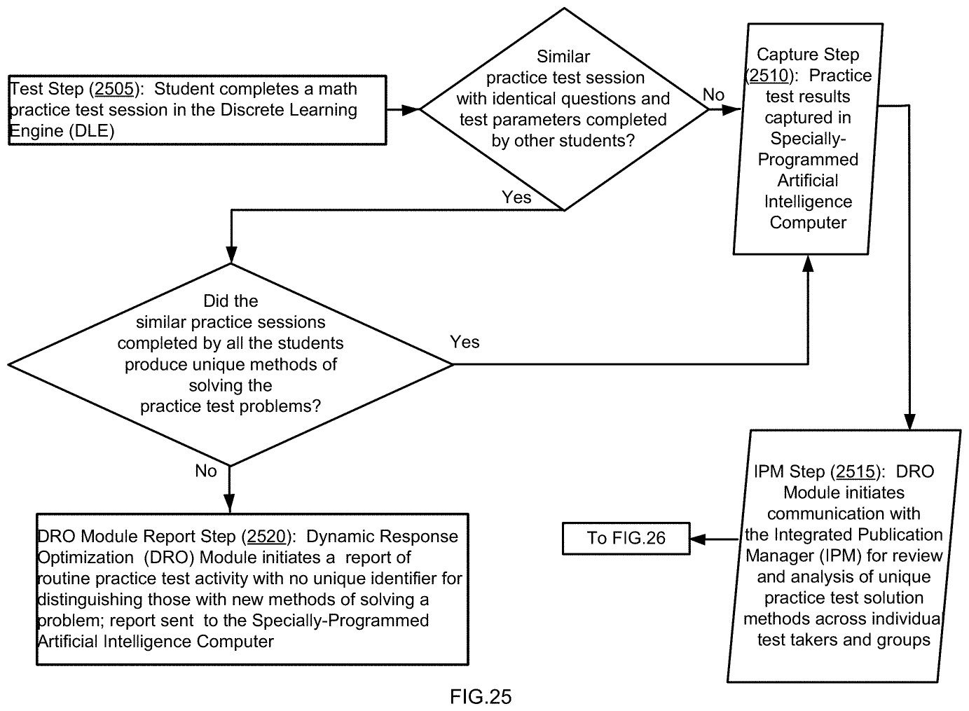

FIG. 25 is an illustration of steps involved in student testing and the responses of the Discrete Learning Engine Device.

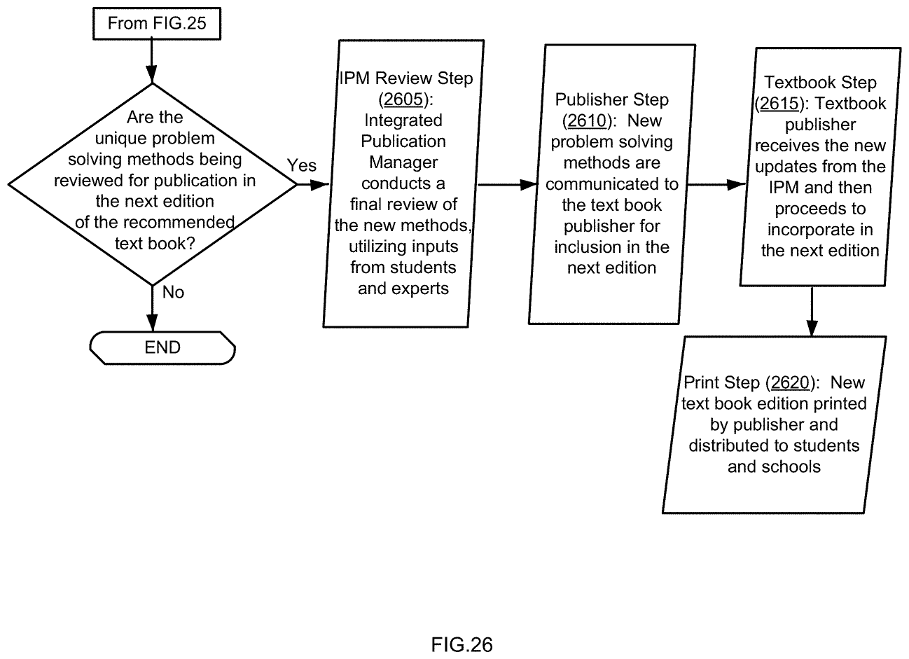

In a Test Step (2505), the student completes a math practice test session in the Discrete Learning Engine Device (105). If there were not similar practice test sessions with identical questions and test parameters completed by other students, then the Discrete Learning Engine Device (105) looks to other testing results. In a Capture Step (2510), the practice test results captured in Specially-Programmed Artificial Intelligence Computer (110). Then the Discrete Learning Engine Device (105) implements an IPM Step (2515) where the Dynamic Response Optimization Module (125) initiates communication with the Integrated Publication Manager (IPM) for review and analysis of unique practice test solution methods across individual test takers and groups. The steps continue in FIG. 26.

If on the other hand, there were similar practice test sessions with identical questions and test parameters completed by other students, then the Discrete Learning Engine Device (105) seeks to determine if the similar practice sessions completed by all the students produced unique methods of solving the practice test problems. If so, then the Discrete Learning Engine Device (105) returns to the Capture Step (2510) and continues with the IPM Step (2515) and those that follow in FIG. 26. If not, then a DRO Module Report Step (2520) requires the Dynamic Response Optimization Module (125) to initiate a report of routine practice test activity with no unique identifier for distinguishing those with new methods of solving a problem. Further the Dynamic Response Optimization Module (125) sends a report to the Specially-Programmed Artificial Intelligence Computer (110).

FIG. 26 continues this process and is an illustration of the additional steps involved in student testing and the responses of the Discrete Learning Engine Device (105).

When there are unique problem solving methods being reviewed for publication in the next edition of the recommended text book, an IPM Review Step (2605) is implemented wherein the Integrated Publication Manager (120) conducts a final review of the new methods, utilizing inputs from students and experts. Then, a Publisher Step (2610) is performed where new problem solving methods are communicated to a text book publisher for inclusion in the next edition. Then, a Textbook Step (2615) is performed where a textbook publisher receives the new updates from the Integrated Publication Manager (120) and then proceeds to incorporate in the next edition. Finally, a Print Step (2620) is performed wherein a new text book edition printed by the textbook publisher and then distributed to students and schools.

The above-described embodiments including the drawings are examples of the invention and merely provide illustrations of the orthotic foot rest for a pedaling machine. Other embodiments will be obvious to those skilled in the art. Thus, the scope of the invention is determined by the appended claims and their legal equivalents rather than by the examples given.

### INDUSTRIAL APPLICABILITY

The invention has application to the education industry.

What is claimed is:

1. A device to facilitate remote learning, the device, termed a Discrete Learning Engine Device, consisting of a unit connectable to a specially-programmed artificial intelligence computer, the Discrete Learning Engine Device configured to:
enable activation by a user once the Discrete Learning Engine Device is connected to the specially-programmed artificial intelligence computer;
upon activation, engage a Dynamic Response Optimization Module residing on the specially-programmed artificial intelligence computer, the Dynamic Response Optimization Module configured to automate a response to the user when the user sends a question on learning resources embedded in the Discrete Learning Engine Device;
upon activation, engage a Derivative Network Controller residing on the specially-programmed artificial intelligence computer, the Derivative Network Controller configured to create a link to one or more other computers having a similar Discrete Learning Engine Device;
upon activation, enable an Activity Risk Monitor residing on the specially-programmed artificial intelligence computer, the Activity Risk Monitor configured to identify patterns found in use of the learning resources embedded in the Discrete Learning Engine Device; and
upon activation, enable use of an Integrated Publication Manager residing on the specially-programmed artificial intelligence computer, the Integrated Publication Manager configured to derive a conclusion from work by the user with the learning resources embedded in the Discrete Learning Engine Device and to enable any of the one or more other computers linked by the Derivative Network Controller to print this conclusion.

2. The device of claim 1, wherein the unit is a separate, stand-alone unit.

3. The device of claim 1, wherein the unit is installed within the specially-programmed artificial intelligence computer.

4. The device of claim 1, wherein the unit is installed within a personal computer of the user.

5. The device of claim 1, further comprising a component within the Discrete Learning Engine Device, the component configured to connect wirelessly to the specially-programmed artificial intelligence computer.

6. The device of claim 1, further comprising a component within the Discrete Learning Engine Device, the component configured to connect wirelessly to a personal computer of the user.

7. The device of claim 1, further comprising a network connection that enables the unit to be connectable to the specially-programmed artificial intelligence computer through said network connection.

8. The device of claim 1, wherein the Dynamic Response Optimization Module is further configured to collect enrollment information from the user, the enrollment information comprising prior history learning performance statistics, and further configured to use the enrollment information to create a recommendation to the user to address any identified learning gap or academic failure risk.

9. The device of claim 1, further comprising a Learning Path Generator configured to implement diagnostic testing of the user and thereafter further configured to use a result of the diagnostic testing to create a recommendation on goals for learning achievement.

10. The device of claim 1, wherein the Derivative Network Controller is further configured to enable one-on-one communication between the user and any of the one or more other computers to which the link was created.

11. The device of claim 1, further comprising an answer validation key configured to provide step-by-step predictive guided feedback to a diagnostic or practice test session taken by the user as the user solves every step required by the diagnostic or practice test.
